(19) United States
(12) Patent Application Publication
(10) Pub. No.: US 2026/0222772 A1
(43) Pub. Date: Jul. 30, 2026

(54) DEVICE, SYSTEM, AND METHOD FOR ASSESSING WORKER RISK

(71) Applicant: MAKUSAFE CORP., West Des Moines, IA (US)

(72) Inventors: Mark Frederick, Cumming, IA (US); Gabriel Glynn, Ankeny, IA (US); Matthew McMullen, Omaha, NE (US); Todd Kratz, Des Moines, IA (US)

(21) Appl. No.: 19/555,510

(22) Filed: Mar. 3, 2026

Related U.S. Application Data
(63) Continuation-in-part of application No. 18/409,204, filed on Jan. 10, 2024.
(63) Continuation-in-part of application No. 18/918,341, filed on Oct. 17, 2024.
(63) Continuation-in-part of application No. 18/176,748, filed on Mar. 1, 2023.
(60) Provisional application No. 63/315,568, filed on Mar. 2, 2022.
(60) Provisional application No. 63/438,294, filed on Jan. 11, 2023.
(60) Provisional application No. 63/591,813, filed on Oct. 20, 2023.

(51) Int. Cl. H04W 4/30

(52) U.S. Cl. CPC H04W 4/30

(57) ABSTRACT

A system and method for evaluating safety risk of workers is presented. The system includes wearable devices configured to be attached to or carried by workers during a work shift. The wearable device includes sensors configured to sample motion data and/or other sensor data indicative of working conditions and work performed by workers. The wearable device evaluates sensor data to identify instances when sensor data satisfies a set of criteria indicative of events of interest and communicates portions of sensor data to a monitoring system using an adaptive communication method. The monitoring system is configured to evaluate the sensor data to quantify physicality exhibited by workers during a work shift.

### CROSS REFERENCE TO RELATED APPLICATIONS

This application is a continuation-in-part of U.S. patent application Ser. No. 18/409,204 (published as U.S. Pub. No. 2024/0232766) filed Jan. 10, 2024 and titled DEVICE, SYSTEM AND METHOD FOR ASSESSING WORKER RISK, which claims priority to U.S. Provisional Patent Application No. 63/438,294 filed on Jan. 11, 2023 and titled DEVICE, SYSTEM AND METHOD FOR ASSESSING WORKER RISK, each of which is hereby incorporated by reference herein in its entirety, including any figures, tables, or drawings or other information.

This application is also a continuation-in-part of U.S. patent application Ser. No. 18/918,341 (published as U.S. Pub. No. 2025/0127446), filed Oct. 17, 2024 and titled DEVICE, SYSTEM AND METHOD FOR ASSESSING WORKER FATIGUE, which claims priority to U.S. Provisional Patent Application No. 63/591,813, filed Oct. 20, 2023 and titled DEVICE, SYSTEM AND METHOD FOR ASSESSING WORKER FATIGUE, each of which is hereby incorporated by reference herein in its entirety, including any figures, tables, or drawings or other information.

This application is also a continuation-in-part of U.S. patent application Ser. No. 18/176,748 (published as U.S. Pub. No. 2023/0281540) filed Mar. 1, 2023 and titled DEVICE, SYSTEM AND METHOD FOR ASSESSING WORKER RISK, which claims priority to U.S. Provisional Patent Application No. 63/315,568 filed Mar. 2, 2022 and titled DEVICE, SYSTEM AND METHOD FOR ASSESSING WORKER RISK, each of which is hereby incorporated by reference herein in its entirety, including any figures, tables, or drawings or other information. This application is related to U.S. patent application Ser. No. 17/518,644 filed Nov. 4, 2021 and titled DEVICE, SYSTEM AND METHOD FOR ASSESSING WORKER RISK; U.S. patent application Ser. No. 17/977,707 filed Oct. 31 2022 and titled DEVICE, SYSTEM AND METHOD FOR HEALTH AND SAFETY MONITORING; U.S. Pub. No. 2021/0264764 filed May 6, 2021 and titled DEVICE, SYSTEM AND METHOD FOR HEALTH AND SAFETY MONITORING; U.S. Pat. No. 11,030,875, filed on Nov. 20, 2019 and titled SAFETY DEVICE, SYSTEM AND METHOD OF USE; U.S. Pat. No. 10,522,024 filed on Sep. 7, 2018 and titled SAFETY DEVICE, SYSTEM AND METHOD OF USE; and U.S. Pat. No. 10,096,230 filed on Jun. 6, 2017 and titled SAFETY DEVICE, SYSTEM AND METHOD OF USE, each of which is hereby incorporated by reference herein in its entirety, including any figures, tables, or drawings or other information.

This application is related to U.S. patent application Ser. No. 17/962,827 filed Oct. 10, 2022 and titled DEVICE, SYSTEM, AND METHOD FOR OPTIMIZING OPERATION OF PRODUCTION EQUIPMENT; U.S. Pat. No. 11,030,875, filed on Nov. 20, 2019 and titled SAFETY DEVICE, SYSTEM, AND METHOD OF USE; U.S. Pat. No. 10,522,024 filed on Sep. 7, 2018 and titled SAFETY DEVICE, SYSTEM, AND METHOD OF USE; and U.S. Pat. No. 10,096,230 filed on Jun. 6, 2017 and titled SAFETY DEVICE, SYSTEM, AND METHOD OF USE, each of which is hereby incorporated by reference herein in its entirety, including any figures, tables, or drawings or other information.

### FIELD OF THE DISCLOSURE

This disclosure generally relates to monitoring systems. More specifically and without limitation, this disclosure relates to a monitoring system utilizing wearable devices to gather information indicative of work performed and/or work conditions.

### OVERVIEW OF THE DISCLOSURE

Injuries at work are tremendously costly for both the corporation as well as the injured worker. As an example, it is estimated that yearly workers' compensation claims exceed 100 billion dollars, with the average claim in the United State amounting to over 100,000 dollars.

Most, if not all of these work-related injuries are avoidable. In view of the personal cost to the injured worker and the financial cost to the employer, a great amount of energy and effort has been placed on avoiding workplace injuries. Many employers have implemented various systems to avoid accidents ranging from common sense solutions to sophisticated systems, from establishing safety teams and safety managers to hiring third-party safety auditors, and everything in-between. However, despite these many efforts, avoidable injuries continue to occur at an alarming pace.

To better inform and address workplace injuries, some current systems utilize wearable devices to gather data to evaluate movement, physical exertion, biometric data, environmental, or other data relevant to health and/or safety of workers. It is desired to be able to receive data from wearable devices to facilitate monitoring of workers throughout a work shift and facilitate early intervention when safety risks are detected and/or early response to accidents. For example, through careful observation and study it has been discovered that workers are more prone to mistakes and/or accidents when they become fatigued. However, current monitoring systems do not provide the capability to quantify or detect when workers are fatigued. It is also desirable to collect data for an entire work shift to facilitate analysis of worker data. However, in many workplace settings, workers may move around different areas of a workplace center and/or travel to various different locations in the field. Such movement can cause intermittent communication with wearable devices used to collect data. It is also desirable for workers to identify problems and/or potential issues that are observed during a work shift so they may be proactively addressed. However, workers may forget about problems and potential issues they observed if reporting is delayed.

Therefore, there is a need in the art to provide a device, system, and method of use for collecting, reporting and analyzing information relating to or indicative of work performed by workers and/or workplace conditions to better assess physicality of workers and/or risk posed to workers during a work shift.

Thus, it is a primary object of the disclosure to provide a wearable device, system, and method of use that improves upon the state of the art.

Another object of the disclosure is to provide a wearable device, system, and method of use that collects information about the work performed by workers and workplace conditions.

Yet another object of the disclosure is to provide a wearable device, system, and method of use that utilizes an adaptive method of communication to communicate data from wearable devices to a monitoring system.

Another object of the disclosure is to provide a wearable device, system, and method of use that utilizes an adaptive method of communication that ensures that all data is communicated to the monitoring system when communication is intermittent.

Yet another object of the disclosure is to provide a wearable device, system, and method of use that utilizes an adaptive method of communication that utilizes multiple different networks.

Another object of the disclosure is to provide a wearable device, system, and method of use that utilizes an adaptive method of communication that utilizes infrastructure and ad hoc networks.

Yet another object of the disclosure is to provide a wearable device, system, and method of use that utilizes an adaptive method of communication that adjusts the method of communication to fit the needs of each worker.

Another object of the disclosure is to provide a wearable device, system, and method of use that utilizes an adaptive method of communication that adjusts the method of communication based on the work schedule of each worker.

Yet another object of the disclosure is to provide a wearable device, system, and method of use that utilizes an adaptive method of communication that is energy efficient.

Another object of the disclosure is to provide a wearable device, system, and method of use that utilizes an adaptive method of communication that facilitates communication from nearly any location.

Yet another object of the disclosure is to provide a wearable device, system, and method of use that aggregates a great amount of information about the work performed by workers and workplace conditions.

Another object of the disclosure is to provide a wearable device, system, and method of use that eliminates bias in the collection of information about the work performed by workers and workplace conditions.

Yet another object of the disclosure is to provide a wearable device, system, and method of use that eliminates the inconsistency in reporting information about the work performed by workers and workplace conditions.

Another object of the disclosure is to provide a wearable device, system, and method of use that utilizes collected information to assess physicality exhibited by workers and/or worker fatigue during a work shift.

Yet another object of the disclosure is to provide a wearable device, system, and method of use that utilizes collected information to assess safety risks faced during a work shift.

Another object of the disclosure is to provide a wearable device, system, and method of use that aggregates a great amount of information indicative of work performed by workers and workplace conditions to facilitate data analytics.

Yet another object of the disclosure is to provide a wearable device, system, and method of use that is cost effective.

Another object of the disclosure is to provide a wearable device, system, and method of use that is safe to use.

Yet another object of the disclosure is to provide a wearable device, system, and method of use that is easy to use.

Another object of the disclosure is to provide a wearable device, system, and method of use that is efficient to use.

Yet another object of the disclosure is to provide a wearable device, system, and method of use that is durable.

Another object of the disclosure is to provide a wearable device, system, and method of use that is robust.

Yet another object of the disclosure is to provide a wearable device, system, and method of use that can be used with a wide variety of manufacturing facilities.

Another object of the disclosure is to provide a wearable device, system, and method of use that is high quality.

Yet another object of the disclosure is to provide a wearable device, system, and method of use that has a long useful life.

Another object of the disclosure is to provide a wearable device, system, and method of use that can be used with a wide variety of occupations.

Yet another object of the disclosure is to provide a wearable device, system, and method of use that provides high quality data.

Another object of the disclosure is to provide a wearable device, system, and method of use that provides data and information that can be relied upon.

These and countless other objects, features, or advantages of the present disclosure will become apparent from the specification, figures, and claims.

### SUMMARY

In one or more arrangements, a system and method for monitoring worker activity is presented. In one or more arrangements, the system includes a wearable device and a monitoring system. The wearable device is configured to be worn by a worker during a work shift. The wearable device communicates data collected from a plurality of sensors during the work shift to the monitoring system. The wearable device is configured to communicate data to the monitoring system using a plurality of communication methods.

In one or more arrangements, in a first communication method, the wearable device communicates over a WiFi network. In one or more arrangements, in a second communication method, the wearable device communicates over a mobile network via a mobile device. In one or more arrangements, in a third communication method, the wearable device communicates over an ad hoc wireless network formed by the wearable device and one or more additional wearable devices.

In one or more arrangements, the system includes a docking station. The docking station has a socket configured to receive and hold the wearable device. The docking station is configured to charge the wearable device when held within the socket. The docking station has a user interface for the worker to check out the wearable device. In one or more arrangements, when the worker checks out the wearable device, the docking station automatically configures communication settings on the wearable device for at least one communication method of the plurality of communication methods.

In one or more arrangements, the docking station and/or monitoring system is configured to automatically select a communication method for the wearable device to use when the worker checks out the wearable device. In one or more arrangements, the communication method is selected based on worker specific data stored in the docking station and/or monitoring system. In one or more arrangements, the communication method is selected based on a work schedule of the worker. Additionally or alternatively, in one or more arrangements, the wearable device is configured to dynamically select the method of communication during a work shift. In one or more arrangements, the wearable device is configured to dynamically select the method of communication based on sensor data gathered by the wearable device.

In one or more arrangements, wearable devices are configured to form an ad hoc wireless network of the plurality of wearable devices.

In one or more arrangements, the wearable devices are each configured to indicate a weight corresponding to the number of hops in the ad hoc wireless network to a base station 80. The wearable devices are each configured to detect a set of the plurality of wireless devices within range and select the wireless device of the set having the lowest weight for the device to communicate data to the monitoring system.

In one or more arrangements, a system and method for evaluating physicality and safety of workers is presented. In one or more arrangements, the system includes wearable devices configured to be worn by workers during a work shift. The wearable devices have a power source, a wireless communication module and one or more sensors. In one or more arrangements, the sensors include a motion sensor. The wearable devices are configured to evaluate sensor data to identify instances when sensor data satisfies a set of criteria indicative of events of interest. The wearable devices are configured to communicate windows of sensor data that include identified instances of events of interest to a monitoring system. The monitoring system is configured to perform analytics on the sensor data to quantify physicality exhibited by workers during a work shift. In one or more arrangements, the monitoring system is also configured to rank workers according to the determined physicality to facilitate prioritized review of workers having high physicality.

In one or more arrangements, the wearable devices are configured to perform analytics of sensor data on the wearable devices, for example to identify events of interest. In one or more arrangements, the monitoring system is configured to use received sensor data and determined physicality rankings to train one or more machine learning algorithms for use on the wearable device for analytics.

In one or more arrangements, a system and method for assessing worker fatigue is presented. In one or more arrangements, the system includes a monitoring system and a wearable device configured to be worn by a worker during a work shift. The wearable device includes one or more sensors. The one or more sensors includes a motion sensor. The monitoring system is communicatively connected to the wearable device. The wearable device is configured to communicate window of motion data recorded by the motion sensor to the monitoring system. The monitoring system is configured to perform analytics on the motion data received from the wearable device to assess fatigue of the worker.

In one or more arrangements, the monitoring system is configured to assess fatigue of the worker by determining a power level exerted by the worker in each window of the motion data; sorting the determined power levels from highest to lowest to create a power curve; and assessing fatigue of the worker based on the power curve. In one or more arrangements, the monitoring system is configured to identify when the worker has become fatigued based on the power curve. In one or more arrangements, the monitoring system is configured to identify when the worker will become fatigued in the near future based on the power curve. In one or more arrangements, the monitoring system is configured to identify when the worker is becoming fatigued based on a comparison of the power curve to a baseline power curve for the worker. In one or more arrangements, the monitoring system is configured to identify when the worker is becoming fatigued by assessing the power curve using a machine learning algorithm that is trained to identify from the power curve when the worker is becoming fatigued.

In one or more arrangements, the monitoring system is configured to initiate one or more actions to mitigate the risk of accident or injury due to fatigue of the worker. In one or more arrangements, the monitoring system is communicatively connected to a status board configured to display workers currently working at a workstation and the monitoring system is configured to cause the status board to display a visual indicator warning when it is determined that the worker is becoming fatigued.

In one or more arrangements, in response to identifying that a worker is becoming fatigued, the monitoring system is configured to communicate a prompt for the worker to take a break. In one or more arrangements, in response to identifying that a worker is becoming fatigued, the monitoring system is configured to communicate a prompt for the worker to switch to a different work assignment. In one or more arrangements, in response to identifying that a worker is becoming fatigued, the monitoring system is configured to communicate a prompt for the worker to relocate to a more comfortable work location. In one or more arrangements, in response to identifying that a worker is becoming fatigued, the monitoring system is configured to prevent the workers from being permitted access to one or more restricted areas. In one or more arrangements, in response to identifying that a worker is becoming fatigued, the monitoring system is configured to prevent the workers from being permitted to operate one or more pieces of dangerous equipment.

### BRIEF DESCRIPTION OF THE DRAWINGS

FIG. 1 shows a diagram of a system for collection of data indicative of worker activity, and/or health and safety risks, in accordance with one or more arrangements.

FIG. 2 shows a diagram of a wearable device having an electronic circuit for collecting and communicating sensor data to a monitoring system, in accordance with one or more arrangements.

FIG. 3 shows a flow chart of an example process for collecting and processing data by a wearable device, in accordance with one or more arrangements.

FIG. 4 shows an example process performed for collecting and processing data by a wearable device, in accordance with one or more arrangements.

FIG. 5 shows an example process performed for collecting and processing data by a wearable device, in which data windows are stored on the wearable device if wireless communication is unsuccessful, in accordance with one or more arrangements.

FIG. 6 shows an example ad hoc communication network for communicating data from wearable devices to a monitoring system, in accordance with one or more arrangements.

FIG. 7 shows an example process for selecting a method of communication and configuring wearable devices during checkout, in accordance with one or more arrangements.

FIG. 8 shows an example weighting process performed by a wearable device in an ad hoc network, in accordance with one or more arrangements.

FIG. 9 illustrates connectivity and weightings of a set of wearable devices in various states of a first example ad hoc communication network scenario, in accordance with one or more arrangements.

FIG. 10 illustrates connectivity and weightings of a set of wearable devices in various states of a second example ad hoc communication network scenario, in accordance with one or more arrangements.

FIG. 11 illustrates connectivity and weightings of a set of wearable devices in various states of a third example ad hoc communication network scenario, in accordance with one or more arrangements.

FIG. 12 illustrates connectivity and weightings of a set of wearable devices in various states of a fourth example ad hoc communication network scenario, in accordance with one or more arrangements.

FIG. 13 shows a state diagram for an example process flow between a detector mode 200, a worker mode 202, and a repeater mode 204.

FIG. 14 shows an example process that may be performed by charging base 18 to sync stored data when a wearable device 12 is checked in, in accordance with one or more arrangements.

FIG. 15 shows a flow chart of an example process for processing data received from wearable devices, in accordance with one or more arrangements.

FIG. 16 shows a flow chart of an example process for quantifying physicality of workers using data received from wearable devices, in accordance with one or more arrangements.

FIG. 17 shows a flow chart of an example process for processing data received from wearable devices, in accordance with one or more arrangements.

FIG. 18 shows a screenshot view of an example user interface, in accordance with one or more arrangements, the view showing the user interface providing a “Users” tool that is configured to provide information for individual workers.

FIG. 19 shows a screenshot view of an example user interface, in accordance with one or more arrangements, the view showing the user interface providing a “Motion Explorer” tool that is configured to summarize physicality and/or various motion derived data metrics for workers over a period of time.

FIG. 20 shows a screenshot view of the example user interface and “Motion Explorer” tool of FIG. 19, in accordance with one or more arrangements; the view showing a popup window providing additional detail relating to the risk determination that appears when a user hovers the cursor over one of the blocks in the timeline; the view showing the user hovering the cursor over a block indicating an acceptable status.

FIG. 21 shows a screenshot view of the example user interface and “Motion Explorer” tool of FIG. 19, in accordance with one or more arrangements; the view showing a popup window providing additional detail relating to the risk determination that appears when a user hovers the cursor over one of the blocks in the timeline; the view showing the user hovering the cursor over a block indicating a caution status.

FIG. 22 shows a screenshot view of an example user interface, in accordance with one or more arrangements, the view showing the user interface providing an “Indicators” tool that is configured to facilitate review of identified indications of worker risk (indicators) over a period of time.

FIG. 23 shows a screenshot view of an example user interface, in accordance with one or more arrangements, the view showing the user interface providing a “Work Areas” tool that is configured to facilitate review of workers present in each work area in a specified period of time.

FIG. 24 shows a screenshot view of an example user interface, in accordance with one or more arrangements; the view showing the user interface providing a “Location Detail” tool that is configured to facilitate review of data gathered by a monitoring system in various different locations; the view showing a “Temp” tab selected.

FIG. 25 shows a screenshot view of the example user interface and Location Detail tool of FIG. 24, in accordance with one or more arrangements; the view showing a “Humidity” tab selected.

FIG. 26 shows a screenshot view of the example user interface and Location Detail tool of FIG. 24, in accordance with one or more arrangements; the view showing a “Heat Index” tab selected.

FIG. 27 shows a screenshot view of the example user interface and Location Detail tool of FIG. 24, in accordance with one or more arrangements; the view showing a “CO2” tab selected.

FIG. 28 shows a screenshot view of the example user interface and Location Detail tool of FIG. 24, in accordance with one or more arrangements; the view showing a “TVOC” tab selected.

FIG. 29 shows a screenshot view of the example user interface and Location Detail tool of FIG. 24, in accordance with one or more arrangements; the view showing a “Pressure” tab selected.

FIG. 30 shows a screenshot view of the example user interface and Location Detail tool of FIG. 24, in accordance with one or more arrangements; the view showing a “Sound dBA” tab selected.

FIG. 31 shows a screenshot view of the example user interface and Location Detail tool of FIG. 25, in accordance with one or more arrangements; the view showing a “Light” tab selected.

FIG. 32 shows a screenshot view of an example user interface, in accordance with one or more arrangements; the view showing the user interface providing a “Location Detail” tool that is configured to facilitate review of data gathered by a monitoring system in various different locations; the view showing summary risk indicators and travel of workers in different locations in a selected period of time.

FIG. 33 shows a screenshot view of an example user interface, in accordance with one or more arrangements; the view showing the user interface providing a “Location Detail” tool that is configured to facilitate review of data gathered by a monitoring system in various different locations; the view showing a map summarizing travel of a selected worker.

FIG. 34 shows an example analytics process for performing analytics of data received from wearable devices by a monitoring system, in accordance with one or more arrangements.

FIG. 35 shows a flow chart of an example process for collecting and processing data by a wearable device, in accordance with one or more arrangements; the example process showing the wearable device configured to communicate higher density and lower density data to a monitoring system.

FIG. 36 shows a flow chart of an example process for collecting and processing data by a wearable device, in accordance with one or more arrangements; the example process showing the wearable device configured to produce and communicate lower density data to a monitoring system.

FIG. 37 shows a flow chart of an example process for evaluating data collected by a wearable device to determine power exerted over time, in accordance with one or more arrangements.

FIG. 38 shows an example power curve in accordance with one or more arrangements.

FIG. 39 shows an example process for dynamic creation and/or update of a power curve during a work shift, in accordance with one or more arrangements.

FIG. 40A shows an example power curve updated at approximately 50% of the length of a work shift, in accordance with one or more arrangements; the power curve having a tail end that is higher than the threshold, indicating that the worker has not yet become fatigued.

FIG. 40B shows the example power curve of FIG. 8A updated at approximately 66% of the length of the work shift; the power curve having a tail end of the power curve that remains higher than the threshold, indicating that the worker has not yet become fatigued; the power curve having predicted data points that are also above the threshold, indicating that the worker is not predicted to become fatigued in the near future.

FIG. 40C shows the example power curve of FIG. 8B updated at approximately 80% of the length of the work shift; the power curve having a tail end that remains higher than the threshold, indicating that worker has not yet become fatigued; the power curve having predicted data points that dip below the threshold, indicating that the worker is likely to become fatigued in the near future.

FIG. 41 shows an example process for dynamic creation and/or update of a power curve 570 and prediction of worker fatigue during a work shift, in accordance with one or more arrangements.

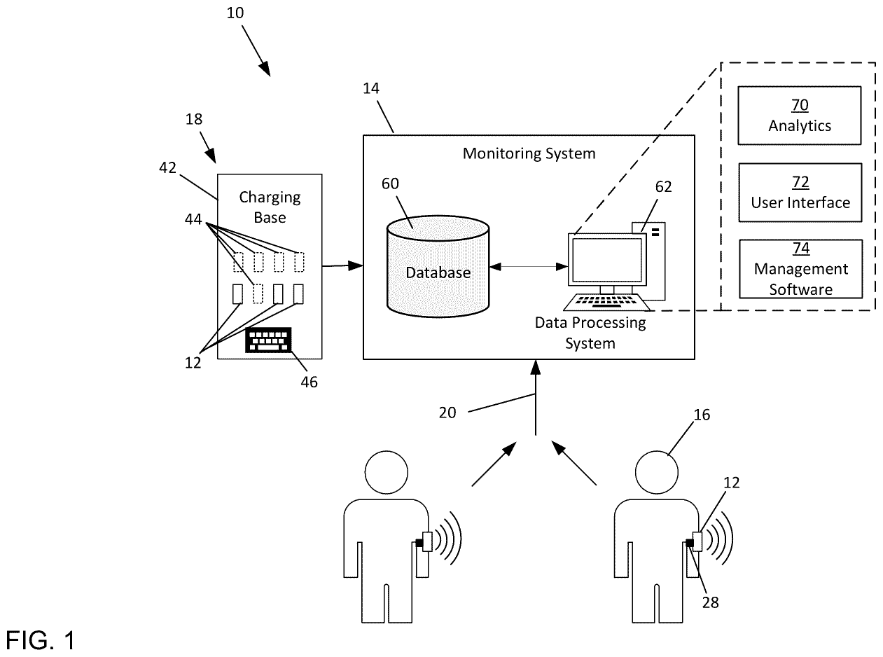

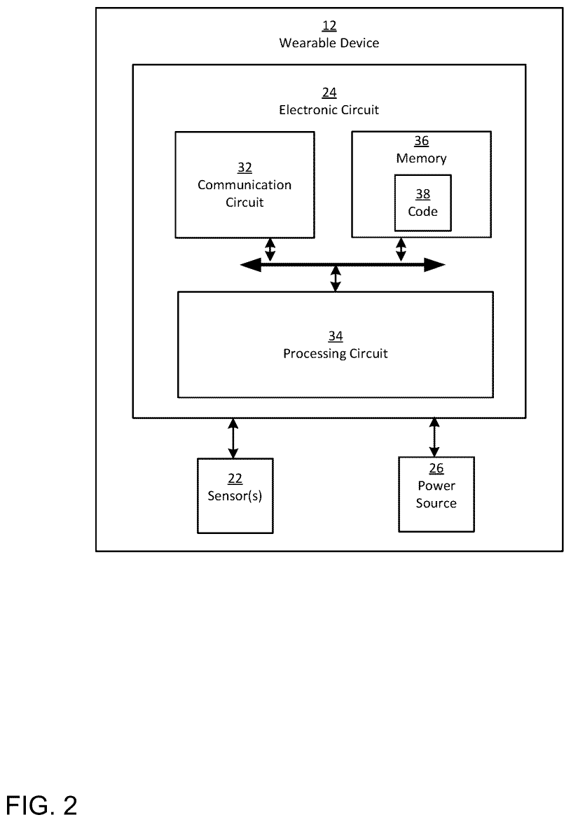

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of gathering information for assessment of physicality and safety risk of workers. However, the embodiments are not so limited. It is appreciated that the embodiments may be adapted for use in other applications which may be improved by the disclosed structures, arrangements and/or methods. The system is merely shown and described as being used in the context of gathering information for assessment of physicality and worker risk for ease of description and as one of countless examples.

### System 10:

With reference to the figures, a system for collection of data indicative of worker activity, and/or health and safety risks 10 is presented (system 10). In one or more arrangements, system 10 includes a plurality of wearable devices 12 and a monitoring system 14 among other components.

### Wearable Devices 12:

Wearable devices 12 are formed of any suitable size, shape, and design and are configured to record motion and/or other data indicative of work performed by workers 16 and/or safety risks encountered by workers 16b during a work shift, such as environmental conditions as well as near misses. In one or more arrangements, recorded information may include, for example, motion of workers 16 (e.g., accelerometer and/or gyroscopic data), location of workers 16 during a work shift, proximity to high risk machinery, air quality, sound levels, data indicative of physicality of tasks performed by workers 16 such as heart rate, temperature, perspiration level, number of steps, distance traveled, and/or other data acquired by sensors of wearable devices 12.

In one or more arrangements, system 10 may include wearable devices 12, charging base 18 and/or other components implemented as described in U.S. patent application Ser. No. 17/518,644 filed Nov. 4, 2021 and titled DEVICE, SYSTEM, AND METHOD FOR ASSESSING WORKER RISK; U.S. Pub. No. 2021/0264764 filed May 6, 2021 and titled DEVICE, SYSTEM, AND METHOD FOR HEALTH AND SAFETY MONITORING; U.S. Pat. No. 11,030,875, filed on Nov. 20, 2019 and titled SAFETY DEVICE, SYSTEM, AND METHOD OF USE; U.S. Pat. No. 10,522,024 filed on Sep. 7, 2018 and titled SAFETY DEVICE, SYSTEM, AND METHOD OF USE; and U.S. Pat. No. 10,096,230 filed on Jun. 6, 2017 and titled SAFETY DEVICE, SYSTEM, AND METHOD OF USE, each of which is hereby incorporated by reference herein in its entirety, including any figures, tables, or drawings or other information.

However, the embodiments are not so limited. Rather, it is contemplated that wearable devices 12 may be implemented using various other devices and/or arrangements configured to acquire sensor data and communicate recorded sensor data to monitoring system 14. In the arrangement shown, as one example, wearable devices 12 each include one or more sensors 22, an electronic circuit 24, and a power source 26 among other components.

### Sensors 22:

Sensors 22 are formed of any suitable size, shape, and design and are configured to record data relating to worker activity, and/or health and safety risks encountered by worker 16 while working. In one or more arrangements, wearable device 12 includes a plurality of sensors 22.

In one or more arrangements, wearable device 12 includes an accelerometer 22A. Accelerometer 22A is formed of any suitable size, shape, and design and is configured to detect acceleration and/or movement of the wearable device 12, such as when a worker 16 trips on something on the floor and almost falls, or when a worker 16 falls off of a ladder, is hit by a fork truck, or has another traumatic event. Accelerometer 22A may be formed of any acceleration detecting device such as a one axis accelerometer, a two-axis accelerometer, a three axis accelerometer or the like. Accelerometer 22A also allows for the detection of changes in acceleration, detection of changes in direction as well as elevated levels of acceleration.

In an alternative arrangement, or in addition to an accelerometer 22A, a gyroscope or gyro-sensor may be used to provide acceleration and/or movement information. Any form of a gyro is hereby contemplated for use, however, in one or more arrangements a three-axis MEMS-based gyroscope, such as that used in many portable electronic devices such as tablets, smartphones, and smartwatches are contemplated for use. These devices provide 3-axis acceleration sensing ability for X, Y, and Z movement, and gyroscopes for measuring the extent and rate of rotation in space (roll, pitch, and yaw).

In another arrangement, and/or in addition to an accelerometer 22A, a magnetometer may be used to provide acceleration and/or movement information. Any form of a magnetometer that senses information based on magnetic fields is hereby contemplated for use. In one or more arrangements, a magnetometer is used to provide absolute angular measurements relative to the Earth's magnetic field. In one or more arrangements, an accelerometer, gyro and/or magnetometer are incorporated into a single component or a group of components that work in corresponding relation to one another to provide up to nine axes of sensing in a single integrated circuit providing inexpensive and widely available motion sensing.

In one or more arrangements, wearable device 12 includes a temperature sensor 22B. Temperature sensor 22B is formed of any suitable size, shape, and design and is configured to detect the temperature of the environment surrounding the worker 16. The same and/or an additional temperature sensor 22B may be configured to detect the temperature of the worker 16 themselves. In one or more arrangements, temperature sensor 22B is a thermometer. Temperature sensor 22B allows for the detection of high or low temperatures as well as abrupt changes in temperature. Temperature sensor 22B also allows for the detection of when a temperature threshold is approached or exceeded. In one or more arrangements, wearable device 12 includes a humidity sensor 22C. Humidity sensor 22C is formed of any suitable size, shape, and design and is configured to detect the humidity of the environment surrounding the worker 16. The same and/or an additional humidity sensor 22C may be configured to detect the humidity level, moisture level or perspiration level of the worker 16 themselves. Humidity sensor 22C allows for the detection of high or low levels of humidity as well as abrupt changes in humidity. Humidity sensor 22C also allows for the detection of when a humidity threshold is approached or exceeded. In one or more arrangements, wearable device 12 includes a light sensor 22D. Light sensor 22D is formed of any suitable size, shape, and design and is configured to detect the light levels of the environment surrounding the worker 16. Light sensor 22D allows for the detection of high or low levels of light as well as abrupt changes in light levels. Light sensor 22D also allows for the detection of when a light threshold is approached or exceeded. In one or more arrangements, light sensor 22D is operably connected to and/or accessible by a light pipe (not shown). Light pipe is any device that facilitates the collection and transmission of light from the environment surrounding the worker 16. In one or more arrangements, the light pipe is a clear, transparent, or translucent material that extends from the exterior of the wearable device 12 to the light sensor 22D and therefore covers and protects light sensor 22D while enabling the sensing of light conditions.

In one or more arrangements, wearable device 12 includes an air quality sensor 22E. Air quality sensor 22E is formed of any suitable size, shape, and design and is configured to detect the air quality of the environment surrounding the worker 16, the particulate matter in the air of the environment surrounding the worker 16, the contaminant levels in the air of the environment surrounding the worker 16, or any particular contaminant level in the air surrounding the worker 16 (such as ammonia, chlorine, or any other chemical, compound or contaminant). Air quality sensor 22E allows for the detection of high contaminant levels in the air as well as abrupt changes in air quality. Air quality sensor 22E also allows for the detection of when an air quality threshold is approached or exceeded.

In one or more arrangements, air quality sensor 22E is a total volatile organic compound sensor, also known as a TVOC sensor. Volatile organic compounds (or VOCs) are organic chemicals that have a high vapor pressure at ordinary room temperature. VOCs are numerous, varied, and ubiquitous. They include both human-made and naturally occurring chemical compounds. Most scents or odors are of VOCs. In this arrangement, air quality sensor 22 is configured to detect VOCs. Also, in one or more arrangements, air quality sensor 22E is accessible through one or more openings in wearable device 12 that provide unfettered access and airflow for sensing by air quality sensor 22E.

In one or more arrangements, wearable device 12 includes a carbon monoxide (CO) sensor 22F. CO sensor 22F is formed of any suitable size, shape, and design and is configured to detect CO levels of the environment surrounding the worker 16. CO sensor 22F allows for the detection of high CO levels in the air as well as abrupt changes in CO levels. CO sensor 22F also allows for the detection of when a CO threshold is approached or exceeded. Of course, sensor 22F, or additional sensors 22, may be used to sense other gasses in the air around the worker 16, such as carbon dioxide, ozone, or any other gas or other content of the air around the worker 16. Also, in one or more arrangements, sensor 22F is accessible through one or more openings in wearable device 12 that provide unfettered access and airflow for sensing by sensor 22F.

In one or more arrangements, wearable device 12 includes a position sensor 22G. Position sensor 22G is formed of any suitable size, shape, and design and is configured to detect the position of the worker 16 within the manufacturing facility. Notably, the term manufacturing facility is to be construed in a broad manner and may include being within one or a plurality of buildings. However, the manufacturing facility may include being outside and unconstrained by the boundaries of a building or any particular grounds. Position sensor 22G allows for the detection of movement of the worker 16 within the manufacturing facility, the speed of movement of the worker 16 within the manufacturing facility, the tracking of the position of the worker 16 within the manufacturing facility, among any other speed, location, direction, inertia, acceleration or position information. This position information can be aggregated over the course of the worker's 16 shift to determine the amount of distance traveled by the worker 16, the average speed, the mean speed, the highest speed, or any other information. In addition, this position information can be aggregated to determine the areas where the worker 16 concentrated their time. In addition, this position information can be correlated with the information detected by the other sensors to determine the concentration of certain environmental factors in different areas of the manufacturing facility. Position sensor 22G may be a GPS device, a wireless device (e.g., Wi-Fi and/or RFID) configured to detect presence of nearby wearable devices, a wireless device that utilizes trilateration from known points, or any other device that detects the position of wearable device 12 and the worker 16.

Wearable device 12 may also include any other sensors 22. For example, in one or more arrangements, wearable device 12 includes one or more sensor 22 that tracks biometric data of the worker 16 including but not limited to, for example, heart rate, blood pressure, blood oxygen levels, blood alcohol levels, blood glucose sensor, respiratory rate, galvanic skin response, bioelectrical impedance, brain waves, and/or combinations thereof.

In one or more arrangements, wearable device 12 includes a sound sensor 22H. Sound sensor 22H is formed of any suitable size, shape, and design and is configured to detect the volume level and/or frequency of sound surrounding the worker 16. In one or more arrangements, sound sensor 22H is a microphone that is accessible through one or more openings in wearable device 12 that provide unfettered access for the sound to reach the microphone. Sound sensor 22H allows for the detection of elevated sounds, abrupt spikes in sounds, loud noises, irritating or distracting frequencies or the like. Sound sensor 22H also allows for the detection of when a volume threshold is approached or exceeded.

During operation, sensors 22 detect environmental conditions, such as sound, temperature, humidity, light, air quality, CO levels, TVOC levels, particulate levels, position and acceleration information, direction information, speed information and the like respectively.

### Electronic Circuit 24:

Electronic circuit 24 is formed of any suitable size, shape, design, technology, and in any arrangement and is configured to facilitate retrieval, processing, and/or communication of data from sensor(s) 22 of wearable device 12 to monitoring system 14. In the arrangement shown, as one example, electronic circuit 24 includes a communication circuit 32, a processing circuit 34, and a memory 36 having software code 38 or instructions that facilitates the operation of wearable device 12.

In one or more arrangements, electronic circuit 24 includes a communication circuit 32. Communication circuit 32 is formed of any suitable size, shape, design, technology, and in any arrangement and is configured to facilitate communication with monitoring system 14. In one or more arrangements, as one example, communication circuit 32 includes a transmitter (for one-way communication) or transceiver (for two-way communication). In some various arrangements, communication circuit 32 may be configured to communicate with monitoring system 14 and/or various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WiFi, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, 4G, 5G, FM/VHF/UHF networks, and/or any other communication protocol, technology or network.

In some various arrangements, electronic circuit 24 and/or communication circuit 32 may be configured to communicate data from sensors 22 to monitoring system 14 (or other device) continuously, periodically, according to a schedule, when prompted by monitoring system 14 (or other device), when wearable device is checked in and connected to charging base 18, and/or in response to any other stimuli, command, or event.

Processing circuit 34 may be any computing device that receives and processes information and outputs commands, for example, according to software code 38 stored in memory 36. For instance, in some various arrangements, processing circuit 34 may be discrete logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 36. Memory 36 may be any form of information storage such as flash memory, ram memory, dram memory, a hard drive, or any other form of memory.

In one or more arrangements, processing circuit 34 and memory 36 may be formed of a single combined unit. Alternatively, processing circuit 34 and memory 36 may be formed of separate but electrically connected components. Alternatively, processing circuit 34 and memory 36 may each be formed of multiple separate but communicatively connected components. Software code 38 is any form of instructions or rules that direct how processing circuit 34 is to receive, interpret and respond to information to operate as described herein. Software code 38 or instructions are stored in memory 36 and accessible to processing circuit 34.

### Power Source 26:

In the arrangement shown, as one example, wearable device 12 includes a power source 26. Power source 26 is formed of any suitable size, shape, design, technology, and in any arrangement or configuration and is configured to provide power to wearable device 12 so as to facilitate the operation of the electronic circuit 24, sensors 22, and/or other electrical components of the wearable device 12. In the arrangement shown, as one example, power source 26 is formed of one or more batteries, which may or may not be rechargeable. Additionally or alternatively, in one or more arrangements, power source 26 may include a solar cell or solar panel that may power or recharge wearable device 12. Additionally or alternatively, in one or more arrangements, power source 26 may be line-power that is power that is delivered from an external power source into the wearable device 12 through a wired connection. Additionally or alternatively, in one or more arrangements, power source 26 may be a wireless power delivery system configured to power or recharge wearable device 12. Any other form of a power source 26 is hereby contemplated for use.

### Attachment Member 28:

In one or more arrangements, wearable device 12 is configured to be worn by a worker 16 and in this way, wearable device 12 is considered to be a wearable device 12. To facilitate being worn by a worker 16 while working, wearable device 12 includes an attachment member 28 connected to or formed into wearable device 12. In some various arrangements, wearable device 12 may utilize various different methods and/or means to attach with a worker 16 including but not limited to, for example, a band, strap, belt, elastic strap, snap-fit member, a clip, hook-and-loop arrangement, a button, a snap, a pin, a zipper-mechanism, a zip-tie member, a magnet, an adhesive, and/or any other attachment means, that are attachable to a worker's arm wrist, arm, ankle, leg, hand, finger, waist, chest, neck, head, or other part of the body or clothing worn by the worker 16. In one or more arrangements, it is desirable to attach the wearable device 12 to the worker's non-dominant arm while working. Alternatively, attachment member 28 may be formed of any other device that connects two components together such as a snap-fit member, a clip, hook-and-loop arrangement, a button, a snap, a zipper-mechanism, a zip-tie member, or the like, just to name a few. As another arrangement, wearable device 12 can be attached to or formed as part of a piece of clothing or equipment, such as a safety vest, a helmet or the like. In one or more arrangements, as is further described herein, wearable device 12 is held within a holster having an attachment member in a removable manner, as is further described herein.

### Wearable Devices 12 In Operation:

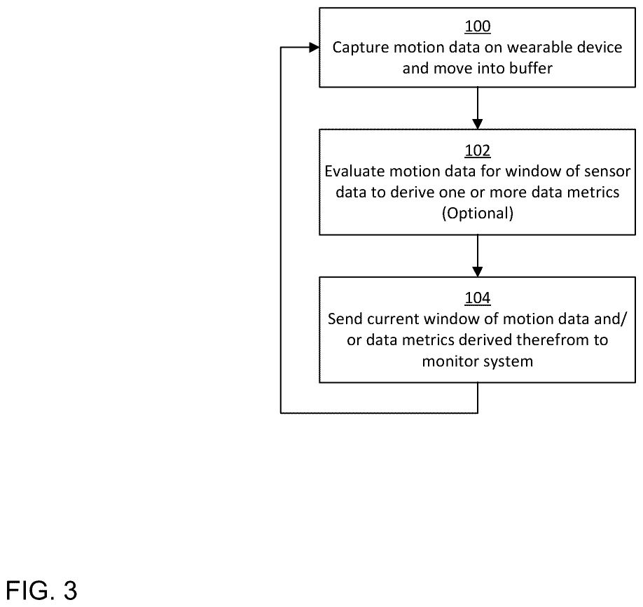

FIG. 3 shows an example process performed for collecting and processing data by a wearable device 12 in accordance with one or more arrangements. In this example, wearable device 12 operates in a continuous loop to capture motion data of a worker 16 during a work shift. At block 100, motion data is retrieved from one or more sensors 22 and placed in a buffer (or memory 36) storing a window of recent motion data (e.g., the most recent 10 seconds). At block 102, the buffered motion data is optionally processed to derive one or more data metrics from the motion data.

At block 104, the current window of motion data and/or data metrics derived therefrom are communicated to monitor system 14. In one or more arrangements, the window of motion data includes 10 seconds of motion data. However, the arrangements are not so limited. Rather it is contemplated that in some various arrangements wearable devices may be configured to communicates motion and/or other sensor data and/or data metrics in any size windows of time.

While some arrangements may be primarily described with reference to wearable devices 12 continuously and/or periodically communicating sensor data and/or data metrics to monitoring system 14 during a work shift, the arrangements are not so limited. Rather, it is contemplated that in some arrangements, wearable devices 12 may be configured to communicate sensor data and/or data metrics in response to detection of notable events. For instance, in some arrangements, electronic circuit 24 is configured to retrieve and evaluate data from sensors 22 to identify events of interest to facilitate selection of sensor data for analysis by monitoring system 14 and/or trigger performance of one or more actions.

For example, in one or more arrangements, electronic circuit 24 of wearable device 12 is configured to capture data from by sensors 22 and periodically communicate the data or data metrics derived therefrom to monitoring system 14. In some various arrangements, such communication of data may be performed, for example, every second, ten seconds, thirty seconds, minute, 5 minutes, or any other suitable duration of time. In some various arrangements, such communication may communicate sensor measurements and/or data metrics from a single point in time, or measurements and/or data metrics collected over a certain window of time.

### Communication of Data In Response to Notable Events:

While some arrangements may be primarily described with reference to wearable devices 12 continuously and/or periodically communicating sensor data and/or data metrics to monitoring system 14 during a work shift, the arrangements are not so limited. Rather, it is contemplated that in some arrangements, wearable devices 12 may be configured to communicate sensor data and/or data metrics in response to the data satisfying a set of criteria For example, in one or more arrangements, electronic circuit 24 of wearable device 12 is configured to continuously monitor data captured by sensors 22 of wearable device 12 of a worker 16 during a work shift and evaluate the data to identify instances in which the data indicates an event of interest (e.g., motion data indicating acceleration/deceleration exceeding a threshold). In response to identifying an event of interest, a segment (or window) of the sensor data in which the event occurred is communicated to the monitoring system for evaluation. Said another way, in some arrangements wearable device 12 pre-evaluates sensor data so as to only communicate sensor data when events of interest occur. Pre-evaluation of sensor data by the wearable device 12 provides several benefits. Power usage by wearable device 12 for communication of data is reduced as less data is required to be transmitted to monitoring system 14. Furthermore, because less data is transmitted by wearable devices 12 more bandwidth is available for communication data and interference and collisions are reduced. Pre-evaluation of sensor data by the wearable device 12 also reduces processing and storage requirements of monitoring system 14.

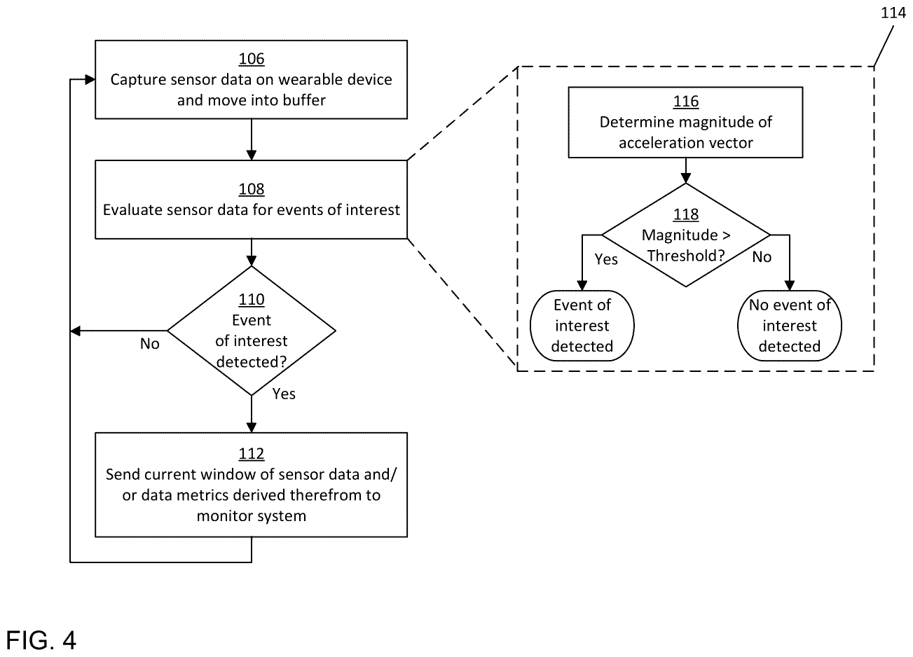

FIG. 4 shows an example process performed for collecting and processing data by a wearable device 12 in accordance with one or more arrangements. In this example, wearable device 12 operates in a continuous loop to capture sensor data of a worker 16 during a work shift. At block 106, sensor data is retrieved from one or more sensors 22 and placed in a buffer (or memory 36) storing a window of recent sensor data (e.g., the most recent 10 seconds). At block 108, the buffered sensor data is evaluated to determine if an event of interest occurred.

Different arrangements may utilize various different criteria and/or processes to identify events of interest. In the example shown, process block 114 shown an example process for identifying events of interest. In this example, events of interest are identified when acceleration in any direction exceeds a threshold. At process block 116, the magnitude of the acceleration vector is determined. Magnitude of the acceleration vector å may be determined by

$$\vert \vec{a} \vert = \sqrt{{x}^{2} + {y}^{2} + {z}^{2}}$$

At decision block 118, the determined magnitude of the acceleration vector is compared to a threshold. In this example arrangement, if the determined magnitude exceeds that threshold an event of interest is detected. Otherwise, an event of interest is not detected. In one or more arrangements, a threshold acceleration of 2 g (19.6133 m/sec²) is used to identify when motion data indicates an event of interest has occurred.

However, the embodiments are not so limited. Rather, other thresholds may be appropriate for identifying events of interest depending on the type of activity that workers 16 engage in during a work shift. For example in one or more arrangements, wearable devices may be configured to process data acquired from motion and/or other sensors, for example using classifiers and/or other analytics processes to identify various events of interest. Such events of interest may include but are not limited to, for example, acceleration exceeding threshold, repetitive motions, excessive noise, adverse temperatures or other working conditions, worker 16 being in close proximity to dangerous equipment, potential accidents or near misses and/or any other notable event that may be pertinent to worker 16 safety and/or management.

If an event of interest is detected, the process proceeds from decision block 104 to process block 106, where the current window of motion data is communicated to monitor system 14. In one or more arrangements, the window of motion data includes 15 seconds of motion data centered on the motion data sample in which the event of interest was detected. In other words, the window of motion data includes approximately 7.5 seconds of motion data preceding the event of interest and 7.5 seconds of motion data following the event of interest. The motion data preceding and following the event of interest may help facilitate further analytics of the motion data. However, the embodiments are not so limited. Rather, it is contemplated that in some various arrangements, wearable device(s) 12 may be configured to use windows of various different lengths of time and/or time period relative to detected events of interest.

If an event of interest is not detected at decision block 104, the process returns to process block 100, where motion data is retrieved from one or more sensors 22 and moved into the buffer. The process repeats in this manner until wearable device 12 is checked-in, powered off, or operation is otherwise disabled. In one or more arrangements, wearable devices 12 are configured to sample data from sensors at approximately 25 hz. However, the embodiments are not so limited. Rather, it is contemplated that wearable devices 12 may sample data from sensors 22 at any frequency as may be appropriate for the type of data.

Although some arrangements are primarily described with reference to communication of certain types of sensor data (e.g., motion data), the embodiments are not so limited. Rather, it is contemplated that wearable devices 12 may communicate data of various other types of sensors in the windows of data in addition to or in lieu of motion data. For example, in one or more arrangements, wearable devices 12 may be configured to communicate data from all sensors 22 in the window of sensor data that is communicated to the monitoring system 14. Data from all sensors may be useful, for example, to facilitate analytics by monitoring system 14.

It is noted that in some arrangements, wearable devices 12 need not communicate a separate window of sensor data for every sample that satisfies criteria for an event of interest. For example, in one or more arrangements, wearable devices 12 may be configured to disable communication of data windows for the same events of interest for a period of after communicating a first window of sensor data for a detected event of interest (e.g., for 1 minute). However, the embodiments are not so limited. Rather, it is contemplated that wearable devices 12 may be configured to disable communication of data windows for any other length of time after communicating a first window of sensor data for a detected event of interest.

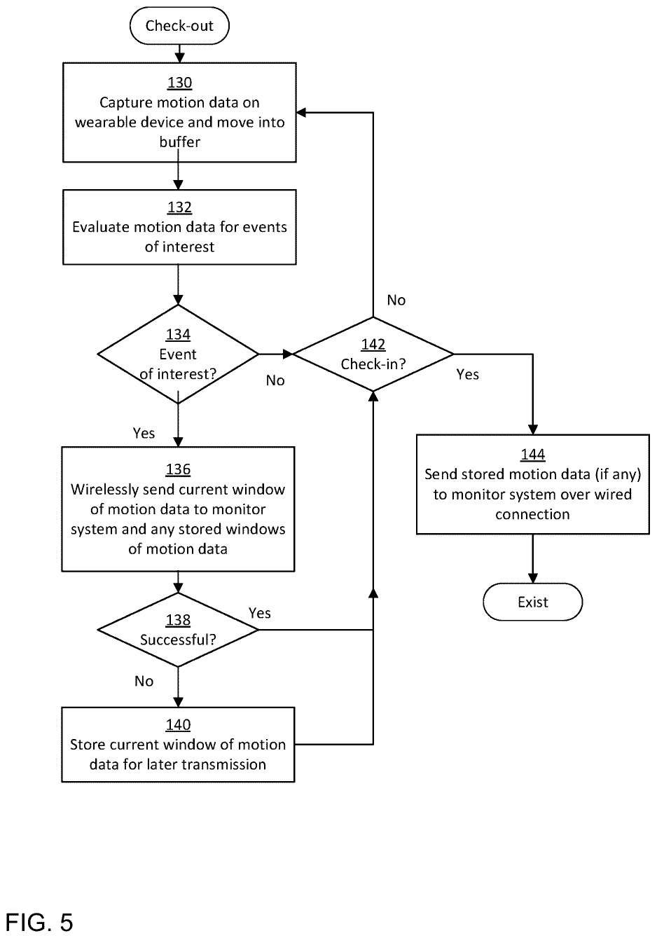

In the arrangement shown in FIG. 4, data is communicated by wearable devices 12 to monitoring system 14 as events of interest are identified. However, the embodiments are not so limited. Rather, it is contemplated that in one or more arrangements, wearable devices 12 may store windows of sensor data corresponding to identified events of interest for later communication to monitoring system 14. For example, in one or more arrangements, wearable devices 12 may store a window of sensor data for later communication to monitoring system 14 if an attempt to wirelessly communicate the window of sensor data is unsuccessful. FIG. 5 shows an example process performed for collecting and processing data by a wearable device 12, in which data windows are stored on the wearable device 12 if wireless communication is unsuccessful, in accordance with one or more arrangements. In this example, wearable device 12 operates in a continuous loop to capture motion data of a worker 16 during a work shift until the wearable device 12 is checked back in by a worker 16.

At process block 130, motion data is retrieved from one or more sensors 22 and placed in a buffer (e.g., a FIFO buffer), which stores a window of recent motion data (e.g., the most recent 10 seconds). At process block 132, the motion data is evaluated to determine if an event of interest occurred and then proceeds to decision block 134.

If an event of interest is not detected at decision block 134, the process proceeds to decision block 142. Otherwise, the process proceeds to process block 136. At process block 136, the current window of motion data is wirelessly communicated to monitoring system 14. If communication is successful at decision block 138, the process proceeds directly to decision block 142. Otherwise, if communication is not successful at decision block 138, the process proceeds to process block 140, where the window of data is stored (e.g., in a memory) for later transmission. The process then proceeds to decision block 142.

In this example, unless the wearable device 12 is checked in, the process proceeds from decision block 134 back to process block 130, where motion data is retrieved from one or more sensors 22 and moved into the buffer. The process loops in this manner until the wearable device 12 is checked in by the worker 16, powered off, or otherwise disabled. In successive loops, when wearable device 12 attempts to communicate the current window of sensor data to monitoring system 14 wearable device 12 also attempts to resend any stored window of sensor data that previously were unable to be communicated. If communication is again unsuccessful, the current window of sensor data is also stored at process block 140. As the process loops, windows of sensor data for events of interest continue to be stored until communication is successful at decision block 138 or the wearable device 12 is checked in. When the wearable device 12 is checked in and connected to charging base 18, the process proceeds from decision block 142 to process block 144, where stored windows of sensor data (if any) are communicated to monitoring system 14 over a wired connection.

Although some arrangements are primarily described with reference to identifying events of interest in motion data, the embodiments are not so limited. Rather, it is contemplated that in some arrangements wearable devices 12 may additionally or alternatively identify events of interest based on data of other sensors and/or data metrics derived therefrom and/or using various different criteria and/or algorithms. In one or more arrangements, wearable devices 12 are configured to perform analytics on sensor data directly on the wearable devices 12 to identify events of interest, generate data metrics, and/or trigger performance of various actions by wearable devices 12. In some various arrangements, actions may include but are not limited to, providing status messages, alerts, or other notification (e.g., emails, SMS, push notifications, automated phone call, social media messaging, and/or any other type of messaging) to a safety manager or other users and/or devices (e.g., computer, table, or smartphone).

Automated Performance of Actions by Wearable Devices 12: In one or more arrangements, wearable devices 12 are configured to perform various preprogrammed actions in response to analytics of sensor data and/or derived data metrics satisfying one or more trigger conditions (e.g., detecting certain events of interest). In one or more arrangements, wearable devices 12 include a configuration data file in memory 36 that specifies one or more trigger condition and one or more actions to be performed when respective trigger conditions are satisfied. The configuration data file may be any form of information that indicates conditions in which wearable device 12 is to perform actions and which actions are to be performed. In one or more arrangements, configuration data file is arranged as a set of rules, where each rule indicates a set of conditions and one or more actions to be performed when the conditions are satisfied. However, it is contemplated that wearable devices 12 may be configured to utilize a configuration data file with any configuration, arrangement, format, or structure.

### Periodic Communication of Data:

Additionally or alternatively, in one or more arrangements wearable devices 12 periodically communicate the sensor data or data metrics derived therefrom to monitoring system 14 in absence of an event trigger 30. In some various arrangements, such communication of data may be performed, for example, every second, ten seconds, thirty seconds, minute, 5 minutes, or any other suitable duration of time. In some various arrangements, such communication may communicate sensor measurements and/or data metrics from a single point in time, or measurements and/or data metrics collected over a certain window of time.

### Higher Density and Lower Density Data:

In one or more arrangements, when an event of interest is detected, the wearable device 12 records and/or transmits and/or saves a higher level or higher density of environmental information such as sound, temperature, humidity, light, air quality, CO levels, position, acceleration and the like and transmits this information to database 60. In one or more arrangements, the wearable device 12 continually tracks and stores a predetermined amount of higher density data, such as sixty-seconds two minutes, thirty seconds, or the like. This higher density data is tracked and stored in a rolling manner. That is, the higher density data is overwritten or converted to lower density data unless an event occurs that causes the wearable device 12 to save and transmit the higher density data.

As one example, when an event of interest is detected, the wearable device 12 stores this higher density information for transmission when wearable device 12 is connected to charging base 18, or the wearable device 12 transmits this information wirelessly over the air when wireless connectivity is established with charging base 18 and/or monitoring system 14. In absence of an event of interest, wearable device 12 stores and/or transmits a lower level or lower density of information, or overwrites a portion of the higher density information.

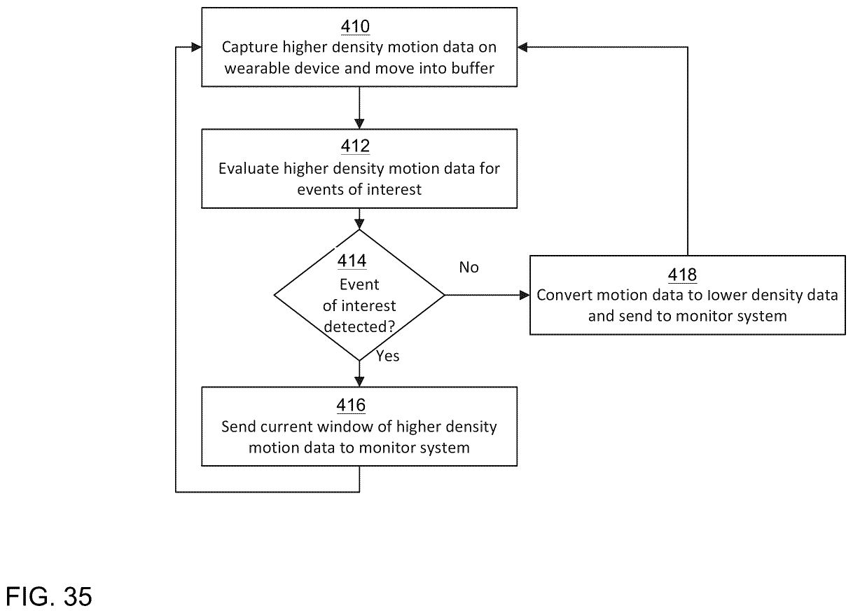

FIG. 35 shows a flow chart of an example process for collecting and processing data by a wearable device that communicates higher density data and lower density data to a monitoring system. In this example, wearable device 12 operates in a continuous loop to capture motion data of a worker 16 during a work shift. At block 410, higher density motion data is retrieved from one or more sensors 22 and placed in a buffer (or memory 36) storing a window of recent motion data (e.g., the most recent 10 seconds). At block 412, the motion data is evaluated to determine if an event of interest occurred as described with reference to FIG. 4.

If an event of interest is detected, the process proceeds from decision block 414 to block 416 where the current window of higher density motion data is communicated to monitor system 14. If an event of interest is not detected at decision block 414, the process proceeds to process block 418, where higher density motion data is converted to lower density data and communicated to monitor system 14. Following process block 416 or process block 418 the process returned to block 410, where the process is repeated.

In this way, a balance can be had between recording a higher density information at and just prior to the time an accident, near miss or notable event occurs, while recording enough information to develop patterns and predict potential accidents while not being overly encumbered by too much data when an accident, near miss or notable event situation has not occurred.

In one or more arrangements, lower density data is provided by simply communicating a subset of samples from higher density data, such that the sample frequency is smaller than that of the higher density data. That is, by way of example, higher density information may include storing and/or transmitting a sample from sensors 22 once every hundredth of a second or tenth of a second, whereas lower density information may include storing and transmitting a data value from sensors once every second or once every two seconds, or the like.

However, the arrangements are not so limited. Rather, it is contemplated that in some various arrangements, lower density data may include data from sensors (or data metrics derived therefrom) in various other formats. As one example, in one or more arrangements, wearable devices may summarize higher density data-values within each lower density sample period (e.g., every second or once every two seconds, or the like). Such summary may include but is not limited to, for example an average value of the samples within the lower density sample period, a maximum value within the lower density sample period, a minimum value within the lower density sample period, and/or any other data metric derived from sensor data samples in the sample period (e.g., classification of motion, activity, events, classification, or other item indicated by the sensor data in the sample period).

While some arrangements are described with reference to wearable devices 12 that communicate higher density sensor data or full sensor data to monitoring system 14, the arrangements are not so limited. Rather, it is contemplated that in some arrangements, wearable devices 12 may be configured to solely or primarily communicate lower density sensor data to monitoring system 14.

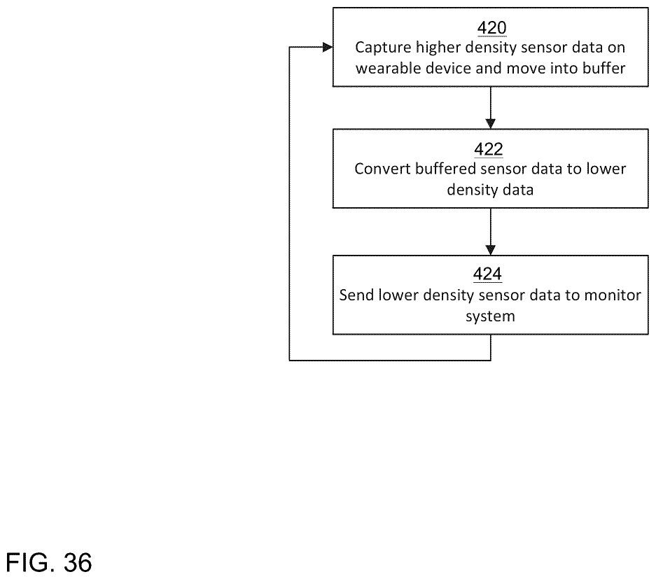

FIG. 36 shows a flow chart of an example process for collecting and processing data by a wearable device that converts data to a lower density format before it is communicated to monitoring system 14. In this example, wearable device 12 operates in a continuous loop to capture data from sensors 22 of wearable device 12 of a worker 16 during a work shift. In this example, at block 420, higher density motion data (e.g., full sample rate sensor data) is retrieved from one or more sensors 22 and placed in a buffer (or memory 36) storing a window of recent sensor data (e.g., the most recent 10 seconds). At block 422, the buffered sensor data is converted to lower density data as described herein. At block 424, the lower density sensor data is sent by wearable device 12 to monitoring system 14. Conversion of sensor data to lower density helps to facilitate analytics of data by monitoring system 14 (or other analytics system) for an entire work shift without overly burdening wearable devices and wireless networks with communication of higher density data.

### Charging Base 18:

In one or more arrangements, system 10 includes a charging base 18. Charging base 18 is formed of any suitable size, shape, and design and is configured to receive, charge and transfer information from and to wearable devices 12. In the arrangement shown, as one example, charging base 18 includes a back wall 42 that includes a plurality of sockets 44 therein that are sized and shaped to receive wearable devices 12 therein. When wearable devices 12 are placed within sockets 44, wearable devices 12 are charged by charging base 18 and data may be transferred between wearable device 12 and charging base 18 and the other components of the system 10. Charging base 18 also includes a user interface 46 configured to provide the ability for the workers 16 to interact with the charging base 18. User interface 46 may include but is not limited to, for example, a plurality of sensors, a key pad, a biometric scanner, a touch screen or any other means or method input for information.

In one or more arrangements, charging base 18 is configured to facilitate checkout/checking of wearable devices 12 by workers 16. As one example, at the beginning of a shift, a worker 16 engages the charging base 18 using user interface to identify the worker 16 with the system 10 (e.g., by biometrically scanning in with a finger or thumb print, a retinal scan, facial recognition, voice recognition, inputting a name or identifier, swiping an ID card, and/or any other manner or method of associating their personal identification with the system 10).

Upon receiving this information, charging base 18 and system 10 identifies the worker 16 and allocates a wearable device 12 held within one of the sockets 44 of the charging base 18 that is fully charged, or has the highest charge among the wearable devices 12, and assigns that wearable device 12 to that worker 16 by illuminating the wearable device 12, illuminating the socket 44 that the wearable device 12 is held in, or providing the socket number to the worker 16 or by identifying which wearable device 12 the worker 16 is to take by any other manner, method or means. Once the proper wearable device 12 has been identified to the worker 16, the worker 16 retrieves that wearable device 12 from the charging base 18 and puts on the wearable device 12.

During the work shift, the wearable device 12 gathers data from sensors 22 and communicates data to monitoring system 14 as described herein. At the end of the shift, the worker 16 returns the wearable device 12 to the charging base 18. Once the wearable device 12 is plugged into a socket 44, the charging base 18 begins charging the wearable device 12. If the wearable device 12 has buffered data, charging base 18 retrieves the data from the wearable device 12 and provides the retrieved data to monitoring system 14.

In one or more arrangements, after turning in the wearable device 12 at the end of their shift, the worker 16 is provided with a log of all instances that were identified as events of interest. The information related to each of these potential accidents or near misses and/or notable events is provided to the worker 16 such as time, acceleration, position, temperature, light level, air quality, volume, CO level, the audible recording or converted text of the contemporaneous recording of the incident or notable event. The worker 16 is then provided the opportunity to confirm or deny whether a notable event of interest actually occurred and provide additional information regarding the notable event of interest. This provides the worker 16 the opportunity to clarify the record and provide additional information.

In one or more arrangements, the system 10 may also update the software or firmware on the wearable device 12 and prepare the wearable device 12 for another use while in the charging base. For example, in one or more arrangements, system 10 may from time to time update classifiers or other analytics algorithms used by wearable devices 12 to identify events of interest.

### Adaptive Communication Network

In one or more arrangements, wearable devices 12 are configured to communicate sensor and/or other data to monitoring system 14 over an adaptive communication network 20 that can be tailored to suit the work shift of each individual worker 16. In one or more arrangements, wearable devices 12 are configured to selectably communicate data to monitoring system 14 using any of a plurality of methods of communication, which may include but are not limited to one or more infrastructure networks, (e.g., WiFi and/or cellular networks) and/or one or more ad hoc networks, among others.

### Selection of Communication Method at Checkout:

In one or more arrangements, wearable devices 12 may be configured by a worker 16 based on the work that will be performed during the work shift. For example, in one or more arrangements, when the worker 16 checks out a wearable device from charging base 18, the charging base 18 may prompt the worker 16 to select which communication method to use for communication of sensor data during the upcoming work shift. For example, if the worker 16 will be in the field or at a remote worksite, the work shift may use a user interface of charging base 18 select to use a cellular network for communication of sensor data to monitoring system 14. As another example, if a worker 16 will be primarily working at a single location for the work shift, the worker 16 may select to use WiFi for communication of sensor data to monitoring system 14. As yet another example, if a worker 16 will be moving between several locations during the work shift, the worker 16 may select to use an ad hoc network formed with other wearable devices 12 for communication of sensor data to monitoring system 14.

In one or more arrangements, in response to a worker 16 selecting a method to be used for communication, charging base 18 communicates with the wearable device 12 assigned to the worker 16 to configure the wearable device 12 to use the selected method of communication. In one or more arrangements, charging base 18 is configured to automatically retrieve user connection information (e.g., from monitoring system 14) to facilitate automatic configuration of the wearable device 12 for the selected communication. For example, such user information may include but is not limited to, for example, network/device IDs, group ID, communication channel assignments, login/security credentials, and/or any other information used to establish a network connection. As an illustrative example, such user connection information may include information to establish a relay connection with a smartphone or other personal device of the worker's 16 (e.g., via Bluetooth and/or hotspot) to facilitate communication of data over a cellular network. As another example, such user connection information may include information to establish connections with WiFi networks available in work area(s)/locations of the worker 16. As another example, such user connection information may include information to establish connections with other wearable devices in work area(s)/locations of the worker 16.

Additionally or alternatively, in lieu of selection by a worker 16, in one or more arrangements charging base 18 and/or monitoring system 14 may be configured to automatically select an available method of communication for the worker 16 based on a work schedule, job assignment, and/or other information for the worker 16 (e.g., worker preferences stored in monitoring system 14). As one example, if the worker 16 is scheduled to work in the field for the day, charging base 18 may select to have wearable device 12 communicate data over a cellular network via a smartphone of the worker 16.

Upon configuring the wearable device to use the selected method of communication, charging base 18 identifies the wearable device 12 to the worker 16 (e.g., by illuminating the wearable device 12, illuminating the socket 44 that the wearable device 12 is held in, or providing the socket number to the worker 16 or by identifying which wearable device 12 the worker 16 is to take by any other manner, method or means). Once the proper wearable device 12 has been identified to the worker 16, the worker 16 retrieves that wearable device 12 from the charging base 18 and puts on the wearable device 12. During the work shift, the wearable device 12 gathers data from sensors 2 2 and communicates data to monitoring system 14 using the selected method of communication.

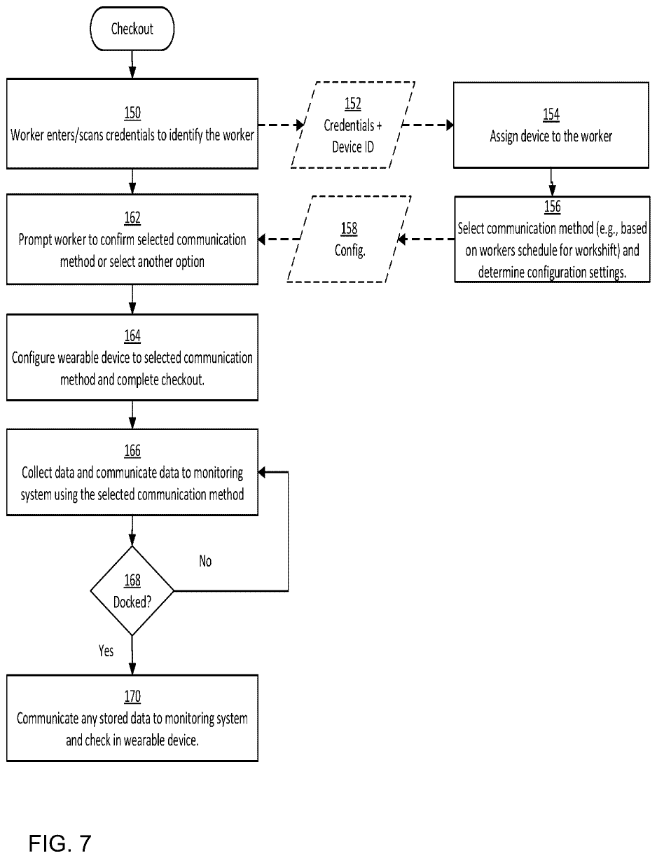

FIG. 7 shows an example process for selecting a method of communication and configuring wearable device 12 during checkout, in accordance with one or more arrangements. At process block 150, a worker 16 engages the charging base 18 using user interface to identify the worker 16 with the system 10 (e.g., by biometrically scanning in with a finger or thumb print, a retinal scan, facial recognition, voice recognition, inputting a name or identifier, swiping an ID card, and/or any other manner or method of associating their personal identification with the system 10).

Upon receiving this information, charging base 18 communicates credentials 152 to monitoring system 14. At process block 154, monitoring system 14 assigns a wearable device 12 to the worker 16. At process block 156, monitoring system 14 selects a communication method to be used by the wearable device 12 (e.g., based on the workers' 16 work schedule for the day and/or saved user preferences) and determines configuration settings 158 for the selected communication method. Configuration settings 158 may include various information to facilitate communication using the selected communication method, which may include but is not limited to, for example, device/network IDs, access credentials, encryption keys, etc. The determined communication settings 158 are communicated from monitoring system 14 to the charging base 18.

In this example arrangement, at process block 162 charging base 18 prompts the worker 16 to confirm the selected communication method or select another option. In one or more arrangements, if another option is selected, charging base 18 may retrieve corresponding configuration settings 158 for the selected communication method. At process block 164, charging base 18 configures wearable device to use the selected communication method to communicate data to the monitoring system 14 during use and prompts the worker 16 to checkout the assigned wearable device 12 to complete checkout (e.g., by illuminating the wearable device 12, illuminating the socket 44 that the wearable device 12 is held in, or providing the socket number to the worker 16 or by identifying which wearable device 12 the worker 16 is to take by any other manner, method or means).

During the worker's 16 work shift, at process block 166, wearable device 12 collects data and communicates the data to monitoring system 14 using the selected communication method, as described herein. The process loops at process block 166 until the worker 16 docks the wearable device 12 at charging base 18 at decision block 168. Once docked, at process block 170 charging base 18 retrieves any data stored on wearable device 12 and communicates the data to monitoring system 14 (if not previously communicated) and completes check in.

### Dynamic Selection of Communication Method During Use:

Although in some arrangements charging base 18 may configure an assigned wearable device 12 to use a selected method of communication when the wearable device 12 is checked out by a worker 16, the arrangements are not so limited. Rather, it is contemplated that in one or more arrangements wearable devices 12 may be configured to dynamically select between communication methods at various times during a work shift. For example, in one or more arrangements, wearable device 12 may be configured to (or prompted to) use a different method of communication in response to data gathered by the wearable device satisfying a particular set of criteria. In some various arrangements, dynamic selection of methods for communication may be based on various data metrics and/or data sources including but not limited to, for example, geolocation of wearable device, proximity to particular equipment, detected wearable devices, time of day, work schedule, network throughput or availability, and/or based on any other data gathered by wearable devices or stored in monitoring system 14.

In one or more arrangements, the criteria for selection of communication methods may be specified by a set of rules in a configuration data file, where each rule indicates a set of trigger conditions and the communication method to be used when the trigger conditions are satisfied. Additionally or alternatively, in some various arrangements, rules in the configuration data file may prompt a wearable device 12 to perform one or more actions in response to particular trigger conditions being satisfied. In some various arrangements, such actions may include but are not limited to, for example, transmitting commands (e.g., a remote control command) to devices, providing status messages and/or sensor data to one or more devices, providing alert messages to one or more users or devices, and/or any other action. Trigger conditions may include, for example, Boolean sensor states, various Boolean functions of sensor values (e.g., threshold value triggers), and/or Boolean logic functions function of a combination of Boolean sensor states and/or Boolean functions. However, embodiments are not so limited. Rather, it is contemplated that in some various embodiments, trigger conditions may be specified in any configuration, arrangement, format, or structure.

### Ad Hoc Communication Network

In one or more arrangements, wearable devices 12 are configured to form an ad hoc communication network as one available method of communicating data to monitoring system 14. In one or more arrangements, such an ad hoc communication network is self-organizing to facilitate connectivity of the wearable devices. In one or more arrangement, the ad hoc communication network is configured to dynamically assemble, reorganize, and/or collapse based on real time data about potential connection routes to adapt to changing conditions. The ability to dynamically adapt increases the reliability of connectivity of wearable devices 12 as workers (and their wearable devices 12) move about a workplace.

In one or more arrangements, wearable devices 12 are configured to communicate between various wireless devices (e.g., wearable devices 12, repeaters, base stations 80, worker detection devices, smartphones, etc.) in the ad hoc network using Bluetooth. However, the arrangements are not so limited. Rather, it is contemplated that in some various arrangements, data may be communicated between wireless devices in the ad hoc network using various wireless communication protocols including but not limited to 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, 4G, 5G, FM/VHF/UHF networks, and/or any other wireless communication protocol, technology or network.

For ease of description, ad hoc communication is primarily described with reference to communication between wearable devices 12. However, the arrangements are not so limited. Rather, it is understood that in various different arrangements, an ad hoc network may be formed by various different wireless devices including but not limited to, for example, wearable devices 12, repeaters, base stations 80, worker detection devices, smartphones, and/or any other device utilizing wireless communication. Furthermore, it is contemplated that in some arrangements, some various nodes in the overall network may be connected in a planned organization (e.g., non-self organizing/non-self assembling) in addition to wearable devices 12 or other nodes that self organizing.

In one or more arrangements, wearable devices 12 are configured to self-organize utilize and dynamically adapt the organization based on changing conditions to direct communication based on a best determined route from wearable devices 12 to a base station 80. In some various different arrangements, wearable devices 12 and/or other devices may utilize various different methods to self-organize and/or optimize routes in the ad hoc communication network

As one example, in one or more arrangements, wearable devices 12 utilize a novel weighting method to self-organize into a network to facilitate communication of data to a base station 80 or other infrastructure communication device communicatively connected to monitoring system 14. For example, in one or more arrangements, wearable devices 12 weight and organize themselves based on the number of hops in the network to reach a base station 80. For instance, a base station 80 is assigned a weight of zero, and communicates this weight to wearable devices 12 in range. In this example arrangement, each wearable device 12 is configured to receive weight from all devices (base stations 80, repeaters, wearable devices, etc.) and select the device with the lowest weight to communicate data to the monitoring system 14. In this example arrangement, each wearable device 12 assigns itself a weight that is one greater than the weight of the device in the network that was selected for communication. In this example arrangement, each wearable device 12 assigns itself a weight of NULL (or other designated value) if the wearable device 12 is not connected to any device providing a communication path to the base station 80. In this manner, each wearable device is assigned a weight that represents the number of hops in the network for the wearable device to communicate data to the base station 80. Wherein each hop corresponds to a wireless transmission link between two devices in the ad hoc network.

Additionally or alternatively, while some arrangements may be primarily described herein with reference to weighting based on the number of hops from a wearable device 12 to a base station 80 in the ad hoc network 20 the arrangements are not so limited. It is contemplated, that in some arrangements, weights in the ad hoc network 20 may be additionally determined based on various factors in addition or in lieu of the number of hops. This may include but is not limited to the strength of signal, throughput, packet loss, delay time, traffic congestion, and/or any other factor or characteristic relevant to wireless communication between a wearable device 12 and any other wireless device that is part of the ad hoc network. As one example, if a wearable device 12 detects multiple other wearable devices with an equal weight (by number of hops) the wearable device may consider other factors and/or characteristics to select which wireless device/wearable device 12 to connect to and exchange data with in the ad hoc network such as the wireless device with the strongest signal or highest throughput.

In one or more arrangements, weights of wearable devices are periodically broadcast by each wearable device 12 to permit each wearable device to update its selection of device to use for communication and update its weight if applicable. Additionally or alternatively, in one or more arrangements, communication of weight by wearable devices 12 may be event driven (e.g., in response to a wearable device changing its weight).

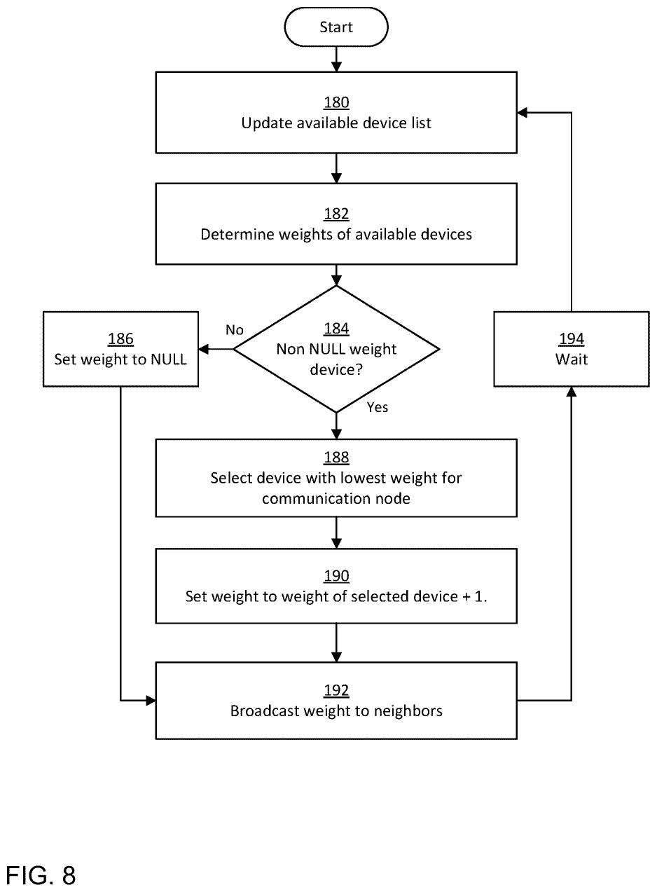

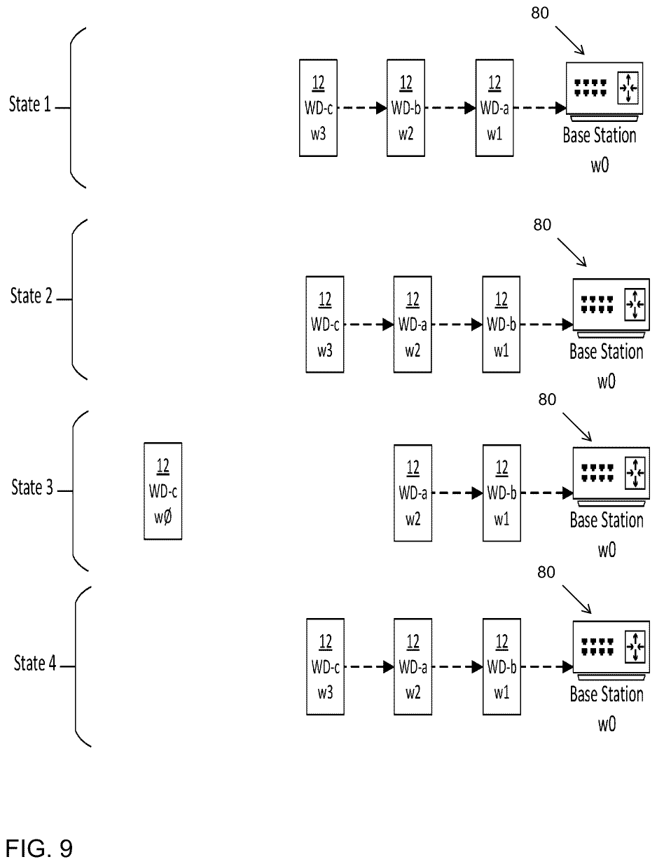

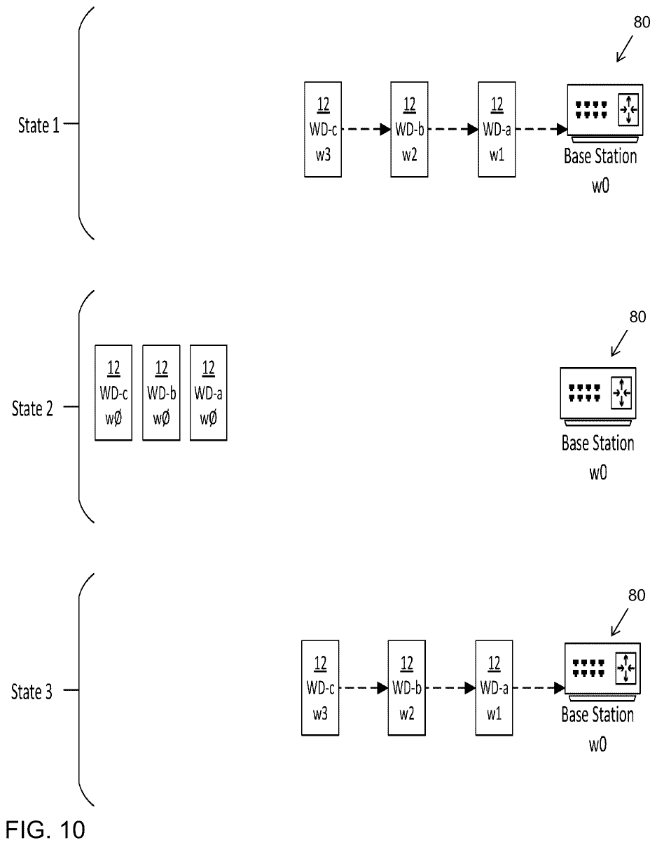

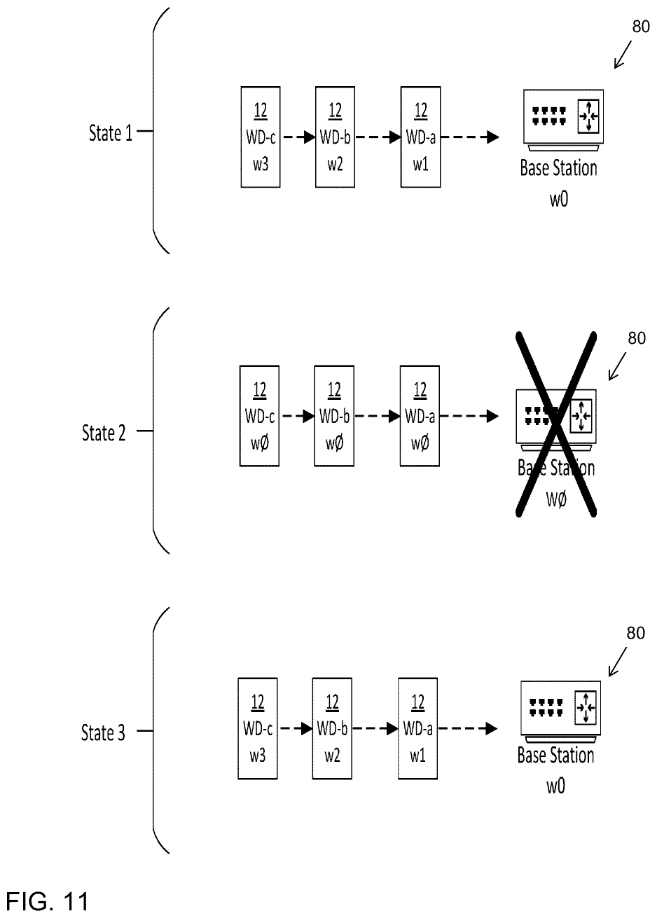

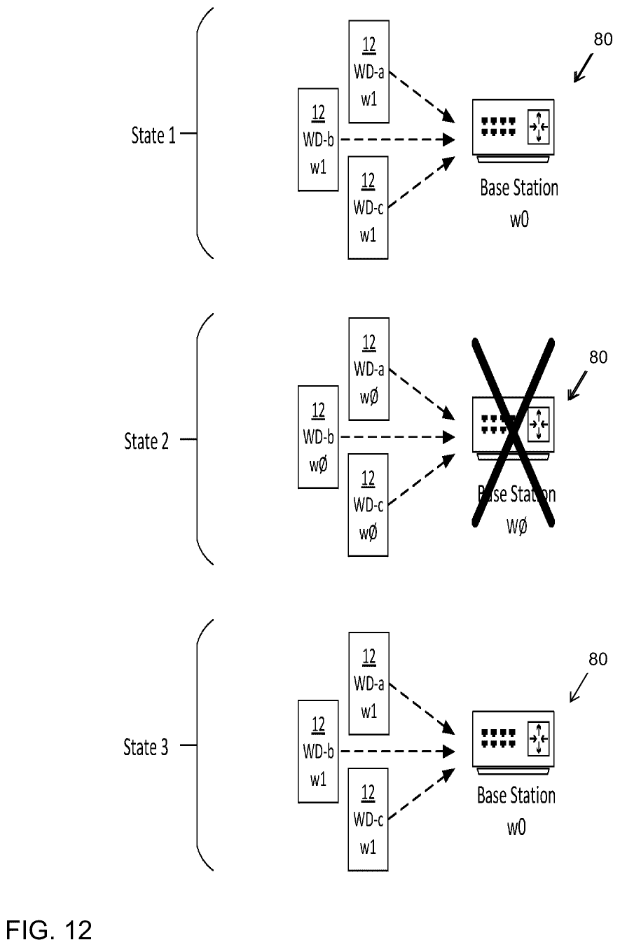

FIG. 8 shows an example weighting process performed by a wearable device 12 in an ad hoc network, in accordance with one or more arrangements. At process block 180, wearable device updates a list of available devices detected by the wearable device 12 (e.g., other wearable devices 12, base stations 80, repeaters and/or other network devices). At process block 182, wearable device 12 determines weights of the available devices. At decision block 184, if all available devices have a NULL weight, the process proceeds to process block 186, where wearable device 12 also sets its weight to NULL. Otherwise, if one or more of the available devices has a non-NULL weight at decision block 184, the process proceeds to process block 188, where wearable device 12 selects the available device having the lowest weight for communication. The process then proceeds to process block 190, where wearable device 12 sets its weight to the weight of the selected device plus one. After setting weight at process block 186 or process block 190, the process proceeds to process block 192, where wearable device 12 broadcasts its weight to other wearable devices 12. In this example arrangement, the process then waits a period of time at process block 194 before returning to process block 180, where the process is repeated.

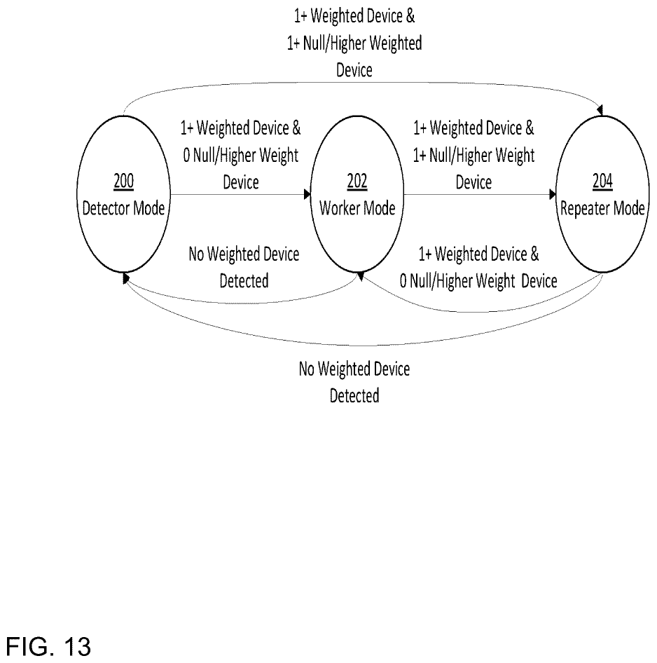

In one or more arrangements, wearable devices 12 in an ad hoc network may be configured to operate in a plurality of different modes depending on weights of other detected devices. FIG. 13 shows a state diagram for an example process flow between a detector mode 200, a worker mode 202, and a repeater mode 204, in accordance with one or more arrangements.

The wearable device 12 initially starts in the detector mode 200 when joining an ad hoc network. Wearable device 12 transitions to detector mode 200 whenever no device with a non-NULL weight is detected. In detector mode, wearable device 12 passively or actively discovers available devices and determines weights of such devices. In this example arrangement, wearable device 12 transitions to worker mode 202 whenever an available device with a non-NULL weight is detected and devices are detected that have a weight that is NULL or higher than the weight of the device. In worker mode 202, wearable device 12 transmits data to monitoring system via the selected lowest weighted device but does not relay data for other wearable devices 12. This encourages other wearable devices to communicate data to infrastructure-based repeaters and/or base stations 80 that are connected to a continuous power supply rather than batteries. In some various arrangements, transmission is initiated by the lower weight wearable device retrieving data from a higher weight device (if data is available). Additionally or alternatively, in some arrangements, transmission may be initiated by the higher weight device.

In this example arrangement, wearable device 12 transitions to repeater mode 204 whenever a non-NULL weight device is available for it to communicate data and one or more other wearable devices have NULL/higher weight than that of the wearable device. In repeater mode 204, the wearable device 12 communicates data that it generates to a selected device and also relays data received from one or more other wearable devices 12.

In some various network implementations, data may be relayed by either infrastructure-based repeaters, wearable devices 12, or both. When a network is setup to use infrastructure-based repeaters, those repeaters are installed at specific fixed locations at a facility to guarantee a network path to a base station 80. In some implementations, a set of wearable devices 12 may be configured to operate as infrastructure-based repeaters and then installed at fixed locations at the facility. In this configuration, the wearable devices 12 that are worn by workers 16 may be configured to have a NULL/max weight. Since data is communicated from high weight devices to lower weight devices, the wearable devices 12 that are worn by workers 16 will never attempt to connect to other wearable devices 12 that are worn by workers 16. When a network is not setup to use infrastructure-based repeaters or does not have enough infrastructure-based repeaters to provide complete coverage, the wearable devices 12 worn by workers 16 may relay data in the network in addition to or in lieu of infrastructure-based repeaters. However, because such wearable devices 12 are not at fixed locations, a network path to a base station 80 is not always guaranteed.

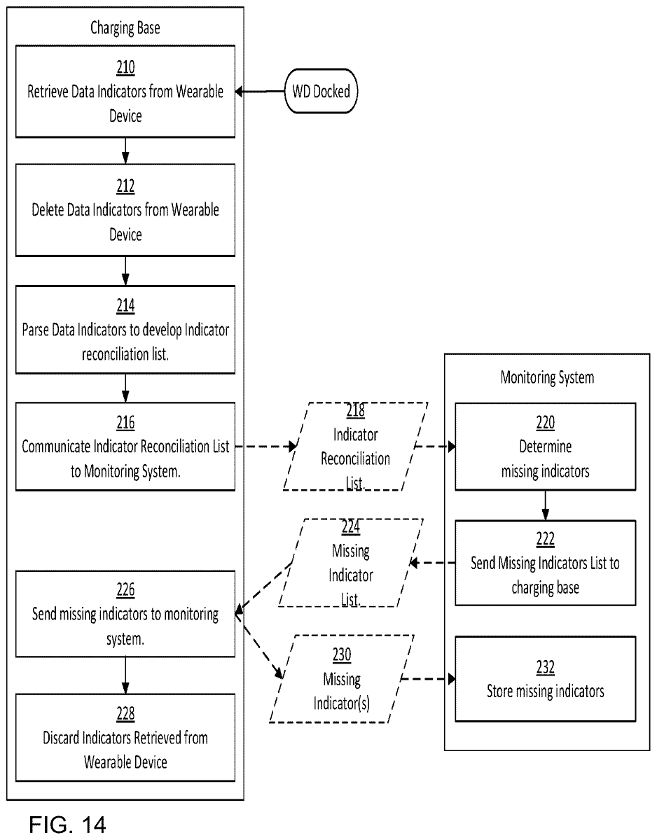

In some arrangements, a wearable device 12 may be configured to store a copy of data it generates when communicating the data via an ad hoc network to ensure the data is not lost as it is relayed through the ad hoc network. For example, a wearable device in repeater mode may become disconnected from other devices before it is able to relay the data received from another wearable device. FIG. 14 shows an example process that may be performed by charging base 18 to sync stored data when a wearable device 12 is checked in, in accordance with one or more arrangements. In this example arrangement, wearable devices 12 stores data as a data indicator. In this example arrangement, when a wearable device 12 is docked, charging base 18 retrieves data indicators from the wearable device 12 at process block 210. At process block 212, charging base 18 deletes data indicators from the wearable device 12. At process block 214, the charging base 18 parses the retrieved data indicators to develop an indicator reconciliation list 218. At process block 216, the indicator reconciliation list 218 is communicated to the monitoring system 14. At process block 220, monitoring system 14 evaluates reconciliation list with data indicators previously received by monitoring system 14 to determine data indicators for missing data. At process block 222, monitoring system 14 sends missing indicator list 224 to charging base 18. At process block 226, charging base 18 sends the missing data indicators 230 specified by the missing indicator list 224 to the monitoring system 14. The monitoring system stores the missing indicators 230 at process block 232. At process block 228, the charging base then discards the data indicators that were retrieved from the wearable device 12.

### Monitoring System 14:

Monitoring system 14 is formed of any suitable size, shape, design and is configured to receive and process sensor data from wearable devices 12 to facilitate analysis of sensor data (e.g., to assess worker physicality, risk, and/or derive various other data metrics). In the arrangement shown, as one example, monitoring system 14 includes a database 60 and a data processing system 62, among other components.

### Database 60:

Database 60 is formed of any suitable size, shape, design and is configured to facilitate storage and retrieval of data. In the arrangement shown, as one example, database 60 is local data storage connected to data processing system 62 (e.g., via a data bus or electronic network 20). However, embodiments are not so limited. Rather, it is contemplated that in one or more arrangements database 60 may be remote storage or cloud based service communicatively connected to data processing system 62 via one or more external communication networks.

In some various arrangements, information recorded by wearable devices 12 may be communicated to database 60 for storage directly (e.g., over electronic network 20) from wearable devices. Additionally or alternatively, in some various arrangements, information recorded by wearable devices 12 may be communicated to database 60 for storage indirectly (e.g., by charging base 18 and/or data processing system 62).

### Data Processing System 62:

Data processing system 62 is formed of any suitable size, shape, and design and is configured to facilitate receipt, storage, and/or retrieval of information in database 60, execution of analytics processes 70, providing of a user interface 72, and/or implementation of various other modules, processes or software of system 10. In one or more arrangements, for example, such data processing system 62 includes a circuit specifically configured and arranged to carry out one or more of these or related operations/activities. For example, data processing system 62 may include discrete logic circuits or programmable logic circuits configured and arranged for implementing these operations/activities, as shown in the figures, and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

### User Interface 72:

User interface 72 is formed of any suitable size, shape, design, technology, and in any arrangement and is configured to facilitate user control and/or adjustment of various components of system 10. In one or more arrangements, as one example, user interface 72 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 72 includes a display (not shown). Display is formed of any suitable size, shape, design, technology, and in any arrangement and is configured to display information of settings, sensor readings, time elapsed, and/or other information pertaining to worker activity and/or health and safety risks; operation of system 10; and/or management of workers 16. In one or more arrangements, the display may include, for example, LED lights, meters, gauges, screen or monitor of a computing device, tablet, and/or smartphone.

Additionally, or alternatively, in one or more arrangements, the inputs and/or display may be implemented on a separate device that is communicatively connected to monitoring system 14. For example, in one or more arrangements, operation of monitoring system 14 may be customized or controlled using a smartphone or other computing device that is communicatively connected to the monitoring system 14 (e.g., via Bluetooth, WiFi, and/or the internet).

### Analytics Processes 70:

In some example arrangements, data processing system 62 is configured to perform various tracking, analytics processes 70, and/or other operations described using data received from wearable devices 12 and/or data stored in database 60.

### Physicality Assessment:

In one or more arrangements, analytics processes 70 are configured to analyze data provided by sensors 22 to assess the physical exertion of workers 16. Jobs requiring high levels of physical exertion may be more likely to result in injury or require more frequent rotation between assigned jobs. For example, in one or more arrangements, analytics processes 70 are configured to quantify the total physicality of tasks performed by workers 16 based on heart rate, temperature, perspiration level, number of steps, distance traveled, accelerometer data, and/or other data acquired by sensors 22 or determined by analytics processes 70 using data analytics (e.g., the determined repetitive motion quantification). In some various arrangements, the analytics processes 70 may generate and store data metrics indicating instances in which a worker 16 exhibits high levels of physical exertion during a work shift. Such data metrics may be useful in assessing safety risk faced by a worker 16 during a work shift, assessing worker 16 productivity, and/or determining work schedules.

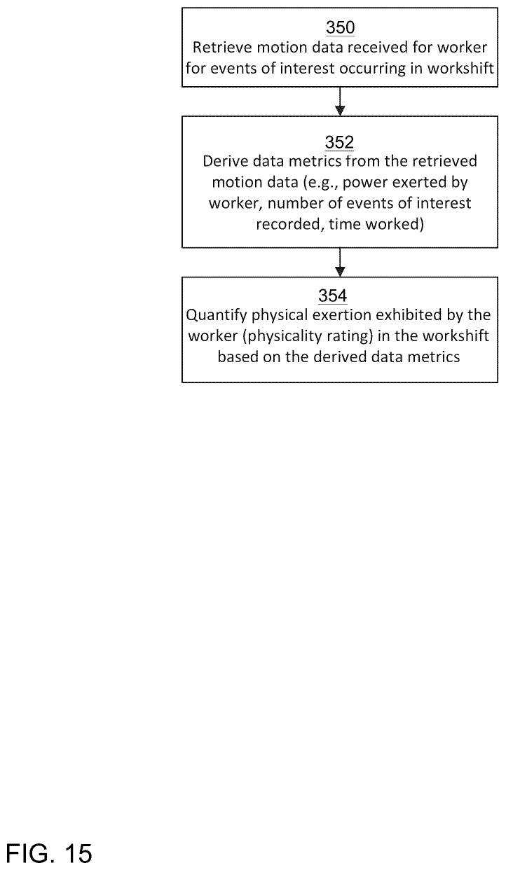

FIG. 15 shows an example arrangement for assessing physicality of a worker 16, in accordance with one or more arrangements. At block 350, sensor data received from wearable device 12 for events of interest is retrieved (e.g., from database 60). At block 352, data metrics (e.g., power exerted by the worker 16, number of events of interest identified, and/or duration of work shifts) are derived from the retrieved data. At block 354, the process quantifies a level physical exertion exhibited by the worker (also referred to a physicality rating) based on the derived data metrics.

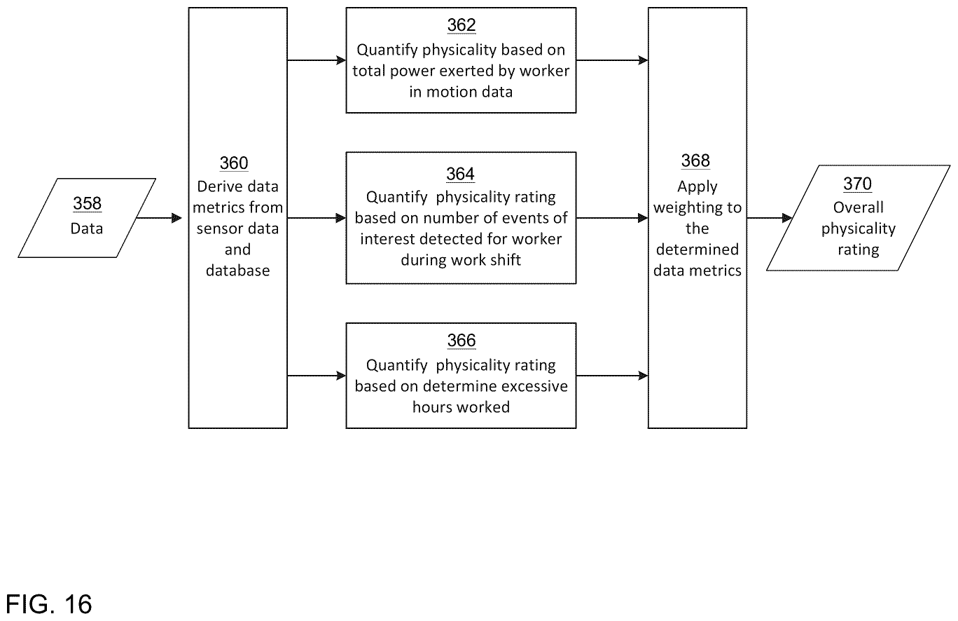

FIG. 16 shows an example dataflow arrangement for assessing physicality of a worker 16, in accordance with one or more arrangements. At block 360, data metrics (e.g., power exerted by the worker 16, number of events of interest identified, and/or duration of work shifts) are derived from the sensor data 358 (and/or other data) in database 60. In this example, the data metrics are process by three analytics processes in parallel by process blocks 362, 364, and 366.

In this example, at processing block 362 a first physicality rating is determined based on total power exerted by the worker that is indicated by the motion data. In one or more arrangements, in determining total power exerted force is calculated based on the magnitude of the acceleration vector as:

$$Force = mass * \vert \vec{a} \vert$$

In one or more arrangements, wearable devices 12 are configured to be worn on the upper arm (between the shoulder and elbow). In such arrangement, force would be calculated using the mass of the arm of the worker 16. In one or more arrangements, an estimated mass of an average arm (e.g., 4.5 kg) is used for force calculation. However, the embodiments are not so limited. Rather, it is contemplated that in some arrangements, analytics processes 70 may calculate force using a more accurate measurement of mass. For example, analytics processes 70 may calculate force using an individual mass measurement specific to each worker that is stored in database 60.

In this example, after calculating force, energy is calculated as:

$$Energy ( J ) = Force * Distance ( meters )$$

In some arrangements, energy may be calculated using the actual distance moved in the window of sensor data (e.g. as indicated by a position sensor 22). In some arrangements, energy may be calculated using an estimated distance moved (e.g., 0.5 meters). After calculating energy, power is then calculated as:

$$Power = \frac{Energy}{time}$$

In one or more arrangements, processing block 362 determines the first physicality rating as a logarithmic function of the total power for all events of interest that occurred in the work shift. For example, in one or more arrangements, block 362 may calculate physicality rating as,

$${Physicality}_{1} = log ( {total}_{power} )$$

At processing block 364 a second physicality rating is determined as a function of the number of events of interest that were detected for the worker 16 in a work shift. With respect to events of interest identified based on magnitude of acceleration, a greater number of events of interest are indicative of more movement by the worker and therefore a higher physicality. In one or more arrangements, a physicality rating may be determined based on the number of detected events of interest that were detected, for example, using a table (e.g., stored in memory) that indicates physicality rating for different number of events of interest. However, the embodiments are not so limited. Rather, it is contemplated that the determination of the second physicality rating may be a function of one or more other variable in addition to the number of events of interest.

In one or more arrangements, processing block 364 determines the second physicality rating as a logarithmic function of the total number of events of interest that were identified in the work shift. For example, in one or more arrangements, block 364 may calculate physicality rating as,

$${Physicality}_{2} = log ( {total}_{{events}_{{of}_{interest}}} )$$

At processing block 366, a third physicality rating is determined as a function of the length of a worker's 16 work shift. Through careful observation it has been surprisingly discovered that for many physically demanding jobs physical toll on workers 16 rapidly increases when work shifts exceed 8.5 hours (510 minutes). In one or more arrangements, processing block 366 is configured to determine a physically rating as a function of the amount of time a worker's 16 work exceeds 510 minutes. Length of each work shift may be determined, for example, by retrieving timekeeper data of the worker 16 from database. In one or more arrangements, processing block 366 determines third physicality rating as a logarithmic function of the amount of time a work shift exceeds 510 minutes. For instance, in one or more arrangements processing block 366 may calculate the third physicality rating with the following pseudocode,

If (510 − shift_length < 0){
then Physicality_3 = (log (abs)(510−shift length));
else Physicality_3 = 0 }.

At processing block 368, the physicality ratings generated by blocks 362, 364, and 366 are weighted and combined to determine an overall physicality rating of the worker 16 for the work shift. In one or more arrangements, processing block 368 is configured to apply weightings and combine physicality ratings as,

$$Total\_Physicality = ( ( Physicality\_ 1 * 0.045 ) + ( Physicality\_ 2 * 0.03 ) + ( Physicality\_ 3 * 0.025 ) )$$

However, the embodiments are not so limited. Rather, it is contemplated that on various different arrangements analytics processes 70 may combine any number of different physicality ratings with any combination of various weightings.

While the arrangements may be primarily described with reference to determination of physicality ratings derived from motion data and length of work shift, the embodiments are not so limited. Rather, it is contemplated that in one or more arrangements, physicality ratings may additionally or alternatively be determined based on a variety of data metrics including but not limited to, for example, motion data, heart rate, temperature, perspiration level, number of steps, distance traveled, and/or other data acquired by sensors 22 and/or derived by analytics processes 70 using data analytics (e.g., identification of repetitive motions).

The example process described with reference to FIG. 4 may be operated in a continuous loop for collecting and processing data by a wearable device 12 during a work shift. However, the arrangements are not so limited. Rather it is contemplated that in some various arrangements wearable devices may be configured to collect and/or communicates motion and/or other sensor data and/or data metrics in continuously, periodically, and/or according to other schedule and/or in any size windows of time.

### Ranking of Workers:

In one or more arrangements, analytics processes 70 are configured to determine and store a total physicality rating (or other physicality assessment) for workers 16 for each work shift (e.g., in database 60). In one or more arrangements, analytics processes 70 are configured to evaluate workers 16 over a desired evaluation period, for example, to facilitate comparative assessment of physicality.

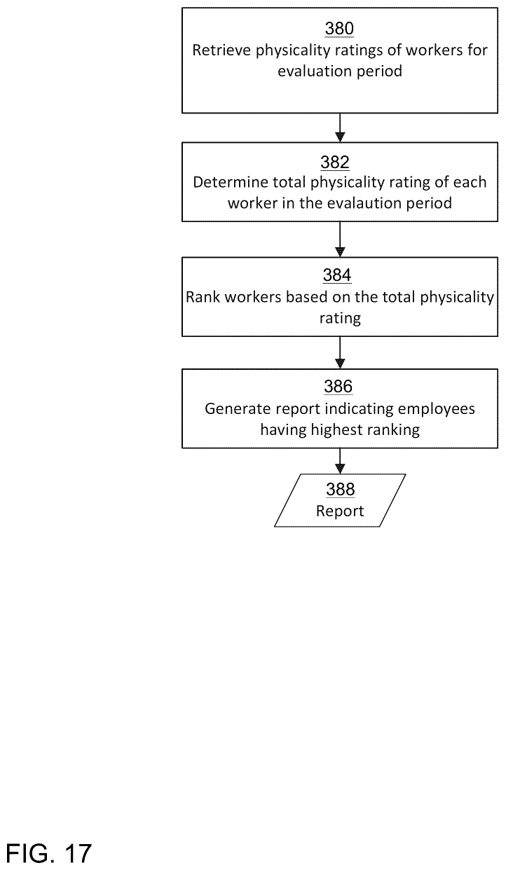

FIG. 17 shows an example process for evaluating physicality ratings of workers 16, in accordance with one or more arrangements. At process block 380, the physicality ratings of workers 16 are retrieved (e.g., from database 60) for each work shift within a specified evaluation period. At process block 382, a total physicality rating is determined for each worker 16 for the evaluation period. In one or more arrangements, total physicality rating for a worker 16 may be determined by calculating an average of the retrieved physicality ratings of the worker 16 for the evaluation period. In this example, workers 16 are ranked based on the determined total physicality rating at process block 384. In this example, a report 388 is generated at process block 386 indicating the workers 16 having the highest ranking.

In one or more arrangements, workers 16 may be categorized into groups based on the total physicality ratings and ranked within each group. For example, in one or more arrangements, analytics processes 70 are configured to categorize workers 16 into five groups (e.g., critical, very high, high, caution, and acceptable) each corresponding to respective range of total physicality. However, the embodiments are not so limited. Rather it is contemplated that workers 16 may be categorized into any number of groups and/or using various different criteria and/or thresholds for categorization. Identification for workers having the highest physicality ratings is useful, for example, to facilitate targeted evaluation of workers' 16 physicality by a manager, for example, to identify and mitigate safety risks to workers 16.

However, the arrangements are not limited to ranking of workers 16 based on physicality. Rather, it is contemplated that in one or more arrangements, analytics processes 70 are configured to rank workers 16 based on various other classifications and/or data metrics in addition to or in lieu of ranking physicality. For example, in some various arrangements, analytics processes 70 configured to rank workers 16 based on various other classifications and/or data metrics including but not limited to, for example, physicality, environmental conditions, overall risk assessment, productivity, throughput, efficiency, and/or any other classification and/or data metric.

### Comparative Rankings:

In one or more arrangements, monitoring system 14 is configured to analyze data of workers 16 of a plurality of different customer companies. In some arrangements, analytics processes 70 are configured to provide a comparative ranking of workers 16 for one customer to workers 16 of one or more other customer companies. For example, in one or more arrangements, analytics processes 70 may be configured to aggregate and anonymized data of all customer companies to facilitate computation of various global data metrics and statistics for comparative purposes. For instance, a company may desire to know how their assessments/rankings compare to overall averages or averages for a select industry. In some arrangements, analytics processes 70 may be configured to automatically notify company management when a particular data metric for workers of the company is below the global/industry average. In this manner, the company may be prompted to investigate the reason for the rating and implement corrective measures.

### Identifying High Risk Events:

In one or more arrangements, analytics processes 70 are configured to process information received from wearable devices 12 and/or data stored in database 60 to derive additional data metrics pertinent to assessment of safety risk of workers 16. In an example arrangement, analytics processes 70 may be configured to evaluate the data using a classifier, state machine, and/or other machine learning algorithm that is trained to identify high risk events (e.g., accidents, trips/falls, near misses, and/or other events indicative of injury or heightened safety risk) that are not directly identified and reported by wearable devices 12. In some arrangements, identified instances may be logged to create a history of high risk events for a worker 16. Such historical data may be useful in assessing safety risks faced by a worker 16 during a work shift.

### Nuanced Motion/Activity Identification and Assessment:

In yet another example arrangement, analytics processes 70 are configured to analyze data of accelerometer 22A (and/or other sensors) to identify motions which may lead to injury over time. Identification of motions/activities may be helpful to identify performance of tasks/scenarios that have a higher risk of injury.

As some illustrative examples, in one or more arrangements, analytics processes 70 may be configured to identify various different motions and/or activities including but not limited to, for example: repetitive lifting, standing, jumping, walking, running, twisting, bending, throwing, ascending and/or descending stairs, ascending and/or descending ladders, egress from an area and/or machine (e.g., from a platform and/or forklift), improper form of motion, posture, lack of motion (e.g., a man down event), dropping of wearable device 12, laughing, coughing, sneezing, and/or any other motion or activity of interest.

In some situations, identification of a particular motion and/or activity may itself be indicative of an incident or increased worker risk (e.g., identification of repeated motion). Identification of repetitive motions may be helpful to facilitate development and execution of measures to avoid such injury. In this example arrangement, analytics processes 70 may be configured to regularly retrieve accelerometer 22A data of workers 16 from database 60 for evaluation (e.g., daily, weekly, or monthly). After retrieving the data, analytics processes 70 processes the data using, for example a classifier, state machine or other machine learning algorithm that is trained to detect and group similar motion events.

In an example arrangement, after processing the data to identify similar motion events, analytics processes 70 determines a set of workers 16 in which a motion or similar group of motions is identified with a high number of occurrences (e.g., exceeding a specified threshold). In this example arrangement, analytics processes 70 then flag the task performed by the workers 16 as a high risk activity.

In one or more arrangements, analytics processes 70 are configured to quantify the level of repetitive motions performed by a worker 16. For example, in one or more arrangements, analytics processes 70 may be configured to quantify repetitive motions based on the number of instances that a worker 16 performs the identified repetitive motions in a certain period of time (e.g., day, week, month). In some various arrangements, the analytics processes 70 may generate reports, e.g., tables, charts, graphs, maps, showing the quantified repetitive motion, for example, for different jobs, workplace areas, different departments, groups and/or individual workers, and/or different shifts or times of day.

Additionally or alternatively, in one or more arrangements, identified motions and/or activities may be used to highlight potential improvements to increase efficiency and/or productivity. For example, frequent use of a particular ladder in a stockroom may be indicative of a frequently retrieved item that may be considered for relocation to another location where the item is easier and/or quicker to access.

### Multi-Variable Analytics:

Moreover, although some arrangements may be primarily described as identifying events of interest or performing analytics based on data from a single sensor or data metric (e.g., acceleration), the embodiments are not so limited. Rather, it is contemplated that in one or more arrangement, wearable devices 12 and/or monitoring system 14 may be configured to use multi-variable classifiers and/or other analytics processes to identify various events of interest. Using multi-variable classifiers/algorithms, more nuanced events of interest may be identified.

As one illustrative example, a classifier configured to identify when a worker encounters insufficient light may benefit from identification of such events based on readings from a light sensor and readings from a gyroscopic sensor. For instance, in certain positions a worker may partially obstruct a light sensor on wearable device 12, thereby making the amount of detected light appear less than it actually is. Accordingly, in some arrangements, a classifier may be configured to determine position/orientation of the wearable device 12 based on the data from the gyroscopic sensor and classify light sensor data different depending on the determined position/orientation.

As another illustrative example, patterns of sensor data indicative of particular events (or other classifications) may depend on the position where wearable device 12 is attached to the body of a worker 16 (e.g., arm, wrist, ankle, hip, etc.). In one or more arrangements, a first classifier may determine where on the body a wearable device is being worn. Another classifier may be trained to then be trained to use that data metric to recognize different patterns depending on where the wearable device is being worn. For example, a classifier may be trained to identify one pattern of motion for climbing a ladder when wearable device 12 is worn on the arm of a worker 16 and a second pattern of motion when the wearable device 12 is worn on the hip of the worker 16.

Similarly, as yet another example, in some arrangements, wearable devices 12 and/or monitoring system 14 may be configured to classify what activities workers 16 are engaging in during a work shift and utilize knowledge of such activity to perform further analytics.

Deviation from Similar Workers

In one or more arrangements, analytics processes 70 are configured to identify workers 16 in which recorded information and/or data metrics deviates from that of other similarly situated workers 16. Such identification of workers 16 may be useful for example to identify workers 16 whose safety risk may be atypical and not accurately represented by the average risk for the worker's 16 occupational role. In one or more arrangements, analytics processes 70 may generate a report indicating workers 16 for which deviations have been identified. In some arrangements, the analytics processes 70 may send the report to a manager for review. In some arrangements, in response to identifying deviations for a set of workers 16, monitoring system 14 may be configured to automatically perform various additional analytics processes 70 to generate data metrics indicative of safety risk faced by the workers 16.

### Trend Analysis:

It is recognized that workers 16 tend to experience increased risk over time, often due to changes in their work environment and/or long hours in difficult conditions. As an illustrative example, a worker 16 may begin to regularly work in low lighting at the end of a long shift. Such low lighting may present risk of fatigue and increase risk of injury. In one or more arrangements, analytics processes 70 are configured to track data metrics (e.g., performance statistics and/or risk assessments) and/or other values of the worker 16 data stored in database 60 to identify when trends occur. In one example arrangement, in response to identifying a trend in the data, analytics processes 70 update data metrics and/or risk assessments for the worker 16.

Additionally or alternatively, in one or more arrangements, analytics processes 70 may compare determine data metric values of the worker 16 for different time periods, for example, to evaluate improvement provided by managerial and/or policy changes (if any). For example, analytics processes 70 may be configured by a user to compare data metrics for a period of time after a new calisthenics/wellness program is implemented to a previous time period to determine if the program has had a positive affect (e.g., reduce risk posed to workers 16 and/or increase productivity).

### Dashboard Interface:

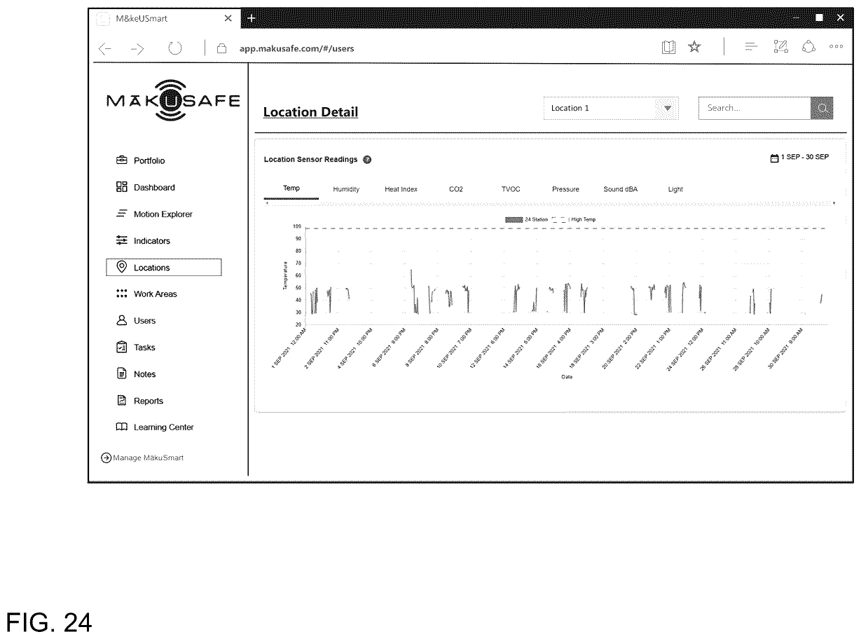

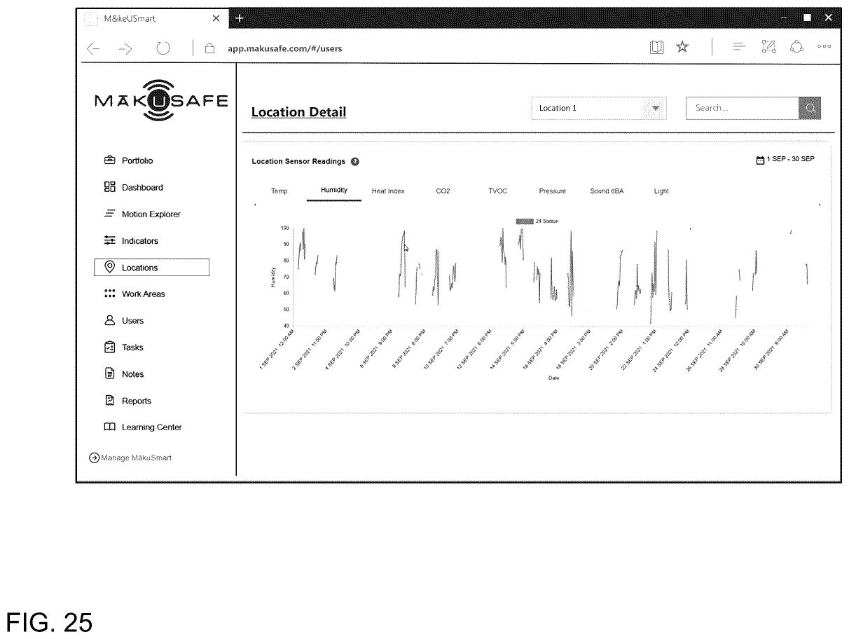

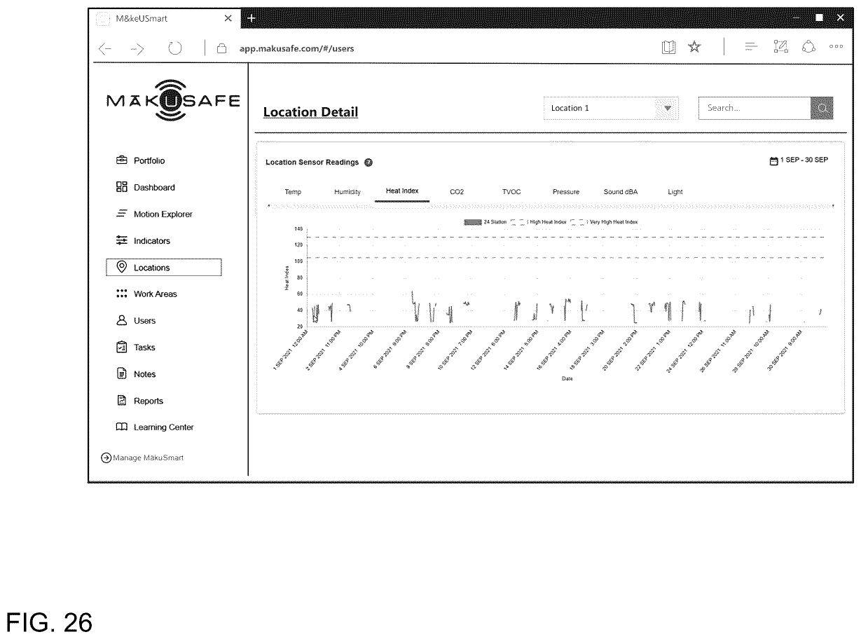

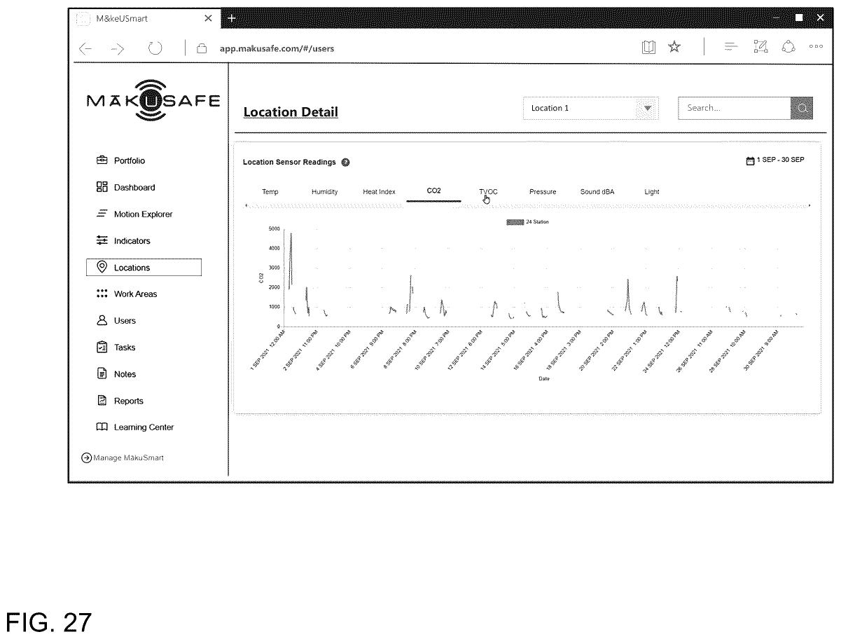

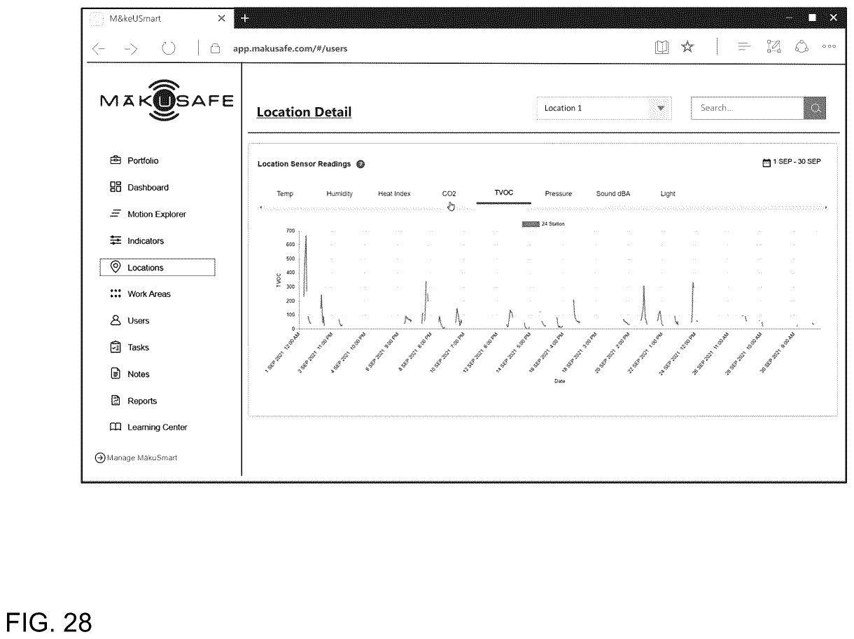

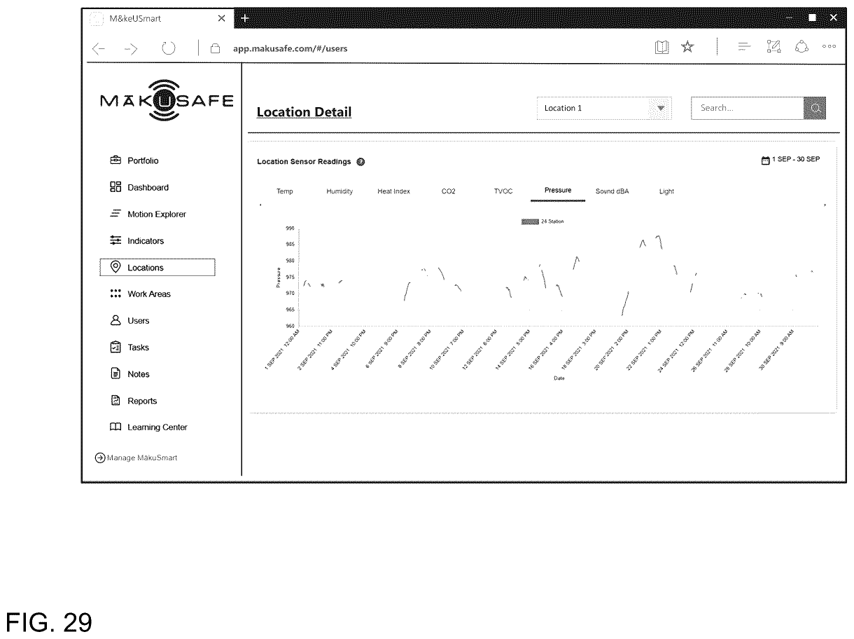

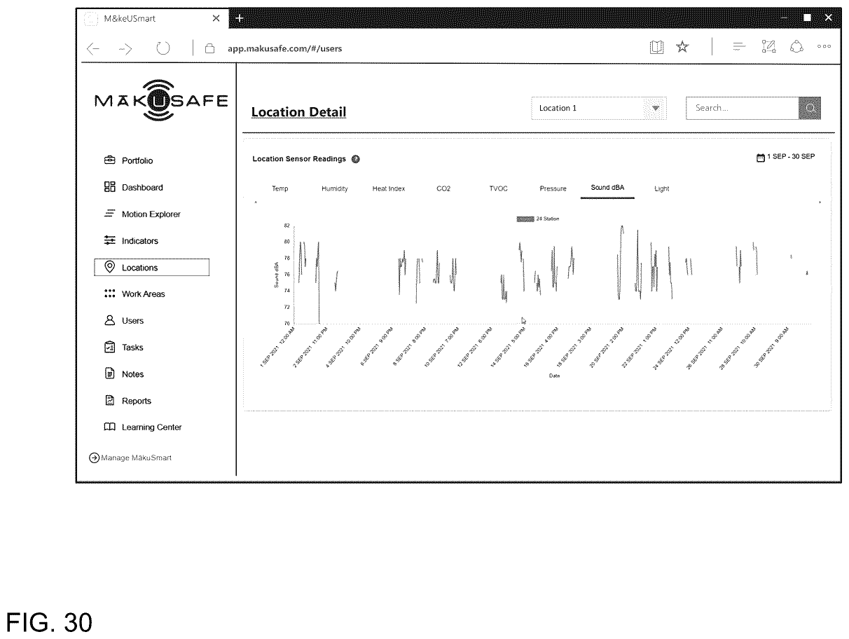

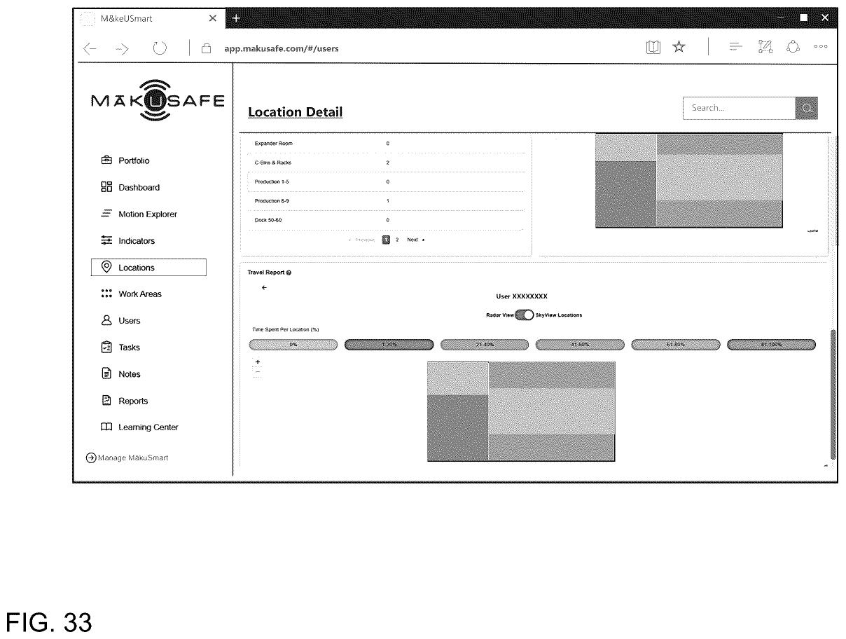

In one or more arrangements, user interface 72 and/or other processes may be configured to provide a dashboard interface to facilitate review and/or evaluation of information and/or data metrics received or derived by monitoring system 14 indicative of physicality and/or safety risks of faced by workers 16. FIGS. 24-39 show screen shots of an example user interface dashboard, consistent with one or more arrangements. In this illustrative example, user interface dashboard provides a number of various different tools to facilitate review and/or evaluation of information and/or data metrics received from monitoring system 14.

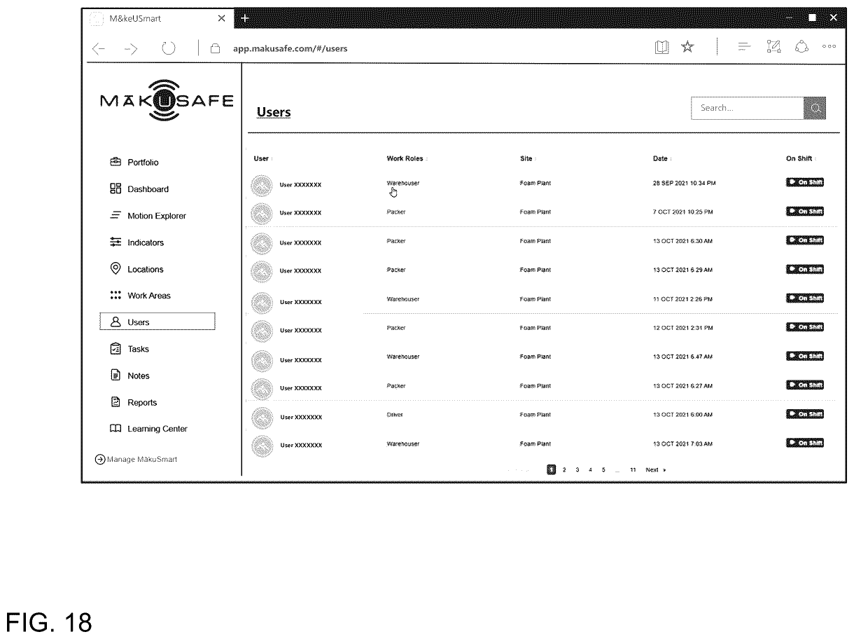

FIG. 18 shows an example “Users” tool provided by user interface dashboard that is configured to provide information for individual workers 16. In this example, the Users tool facilitates review of instances in which workers 16 are identified as performing specific work roles. In this example, each displayed instance indicates a worker 16, the work role that the worker 16 was identified as performing, the site at which the worker 16 was located, the date and time the worker was performing the identified work role, and the current status of the worker. In this example, the Users tool includes a search bar to permit a reviewer to search for identified work role instances for a particular worker.

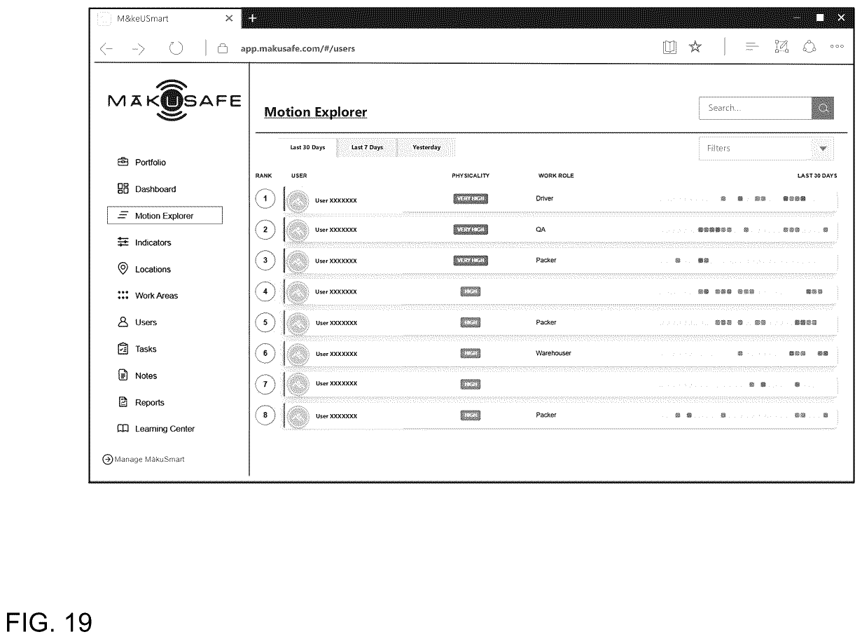

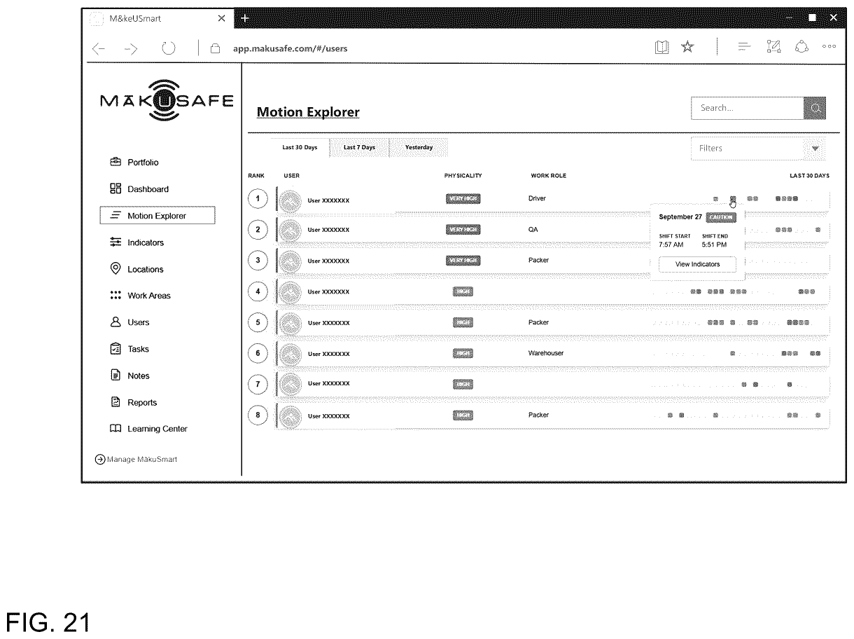

FIGS. 19-21 show an example “Motion Explorer” tool provided by user interface dashboard configured to summarize location based risk of workers 16 over a period of time. In this example arrangement, the Motion Explorer tool allows a user to review a summary of location based risk encountered by workers 16 in various time periods. In this particular example, a user may select to review location based risk data for the last 30 days, the last 7 days, or the previous day. However, the embodiments are not so limited. Rather, it is contemplated that in some various arrangements, the Motion Explorer tool may be configured to provide review of risk data of workers 16 in any time period.

In this example arrangement, the Motion Explorer tool indicates for each worker a physicality level exhibited by the worker 16, the work role performed by the worker 16 (if identified), and a timeline that summarizes location based risk encountered by the worker 16 in the relevant period. In this example arrangement, workers 16 are ranked by the overall level of risk encountered and displayed in ranked order. Such ranking may be useful, for example, to facilitate identification and review of workers 16 that have the greatest potential for workplace injury. However, the embodiments are not so limited. Rather, in this example arrangement the Motion Explorer tool permits a user to select criteria to filter and/or sort users of interest.

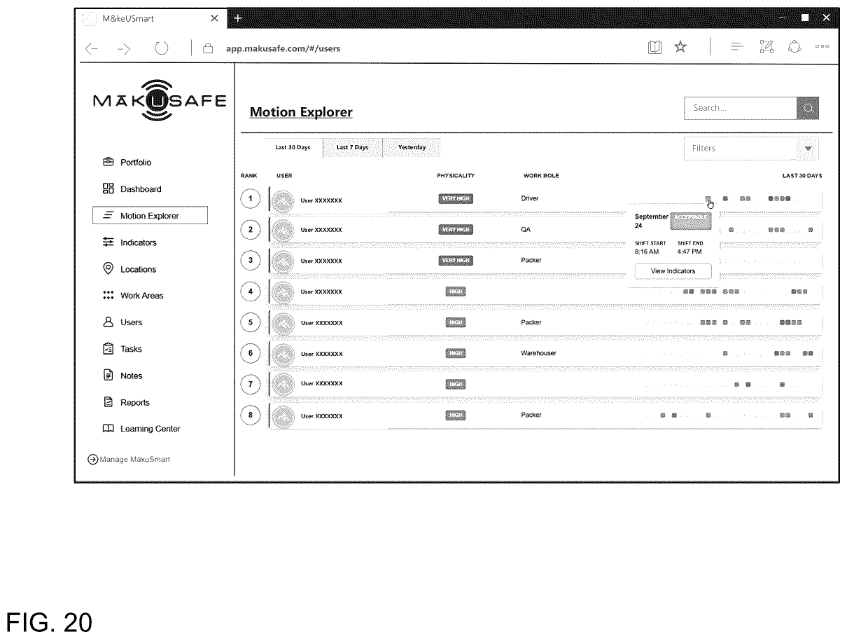

In this example arrangement, the timeline includes a series of blocks representing days of the selected period. In this example arrangement, blocks in the timeline are color coded to indicate the level of risk encountered (with darker colors indicating more risk). As shown in FIG. 20, in this example arrangement, when a user hovers the cursor over one of the blocks in the timeline, a popup window appears that provides additional detail relating to the risk determination. In this example arrangement, the popup window includes a button permitting a user to view the indicators that affected the risk determination. In response to, a user selecting the button, the user interface dashboard displays an Indicators tool.

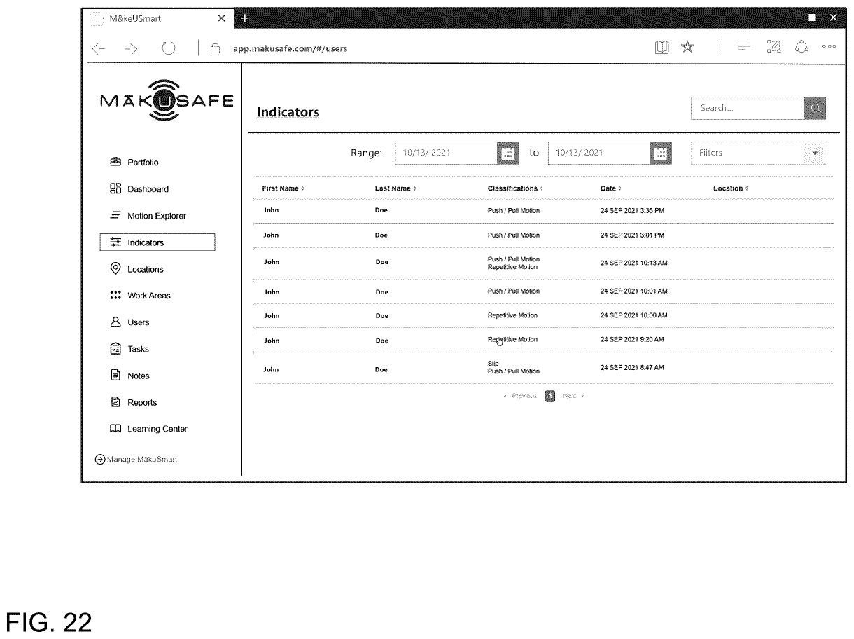

FIG. 22 shows an example “Indicators” tool provided by user interface dashboard configured to facilitate review of identified indications of worker risk (indicators) over a period of time. When the Indicators tool is displayed in response to a user selecting the button of the popup window of the Motion Explorer tool, the Indicators tool shows indicators for the day that was selected by the user. However, in one or more arrangements, the Indicators tool may be configured by user to search for indicators in any specified time period. Furthermore, in this example arrangement, the Indicators tool permits a user to select criteria to filter and/or sort matching indicator records.

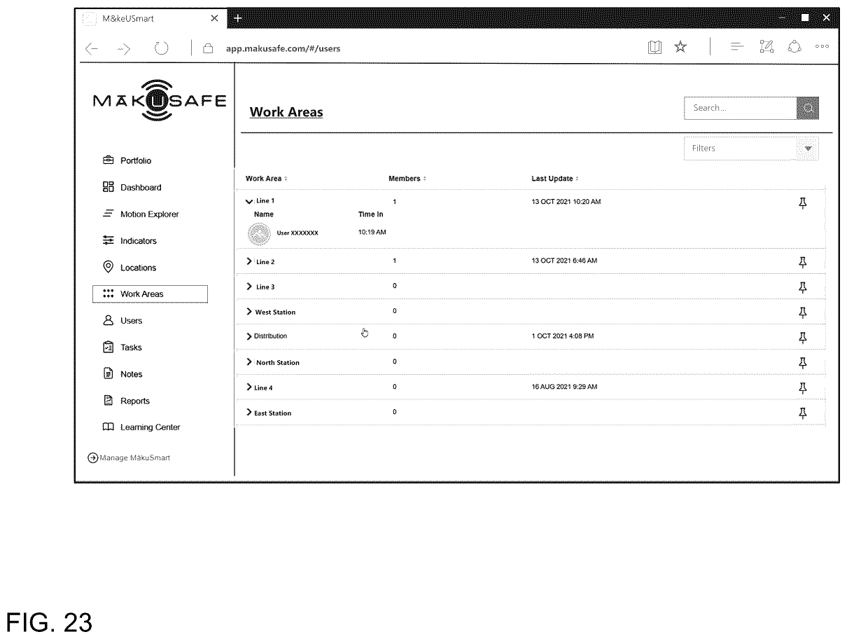

FIG. 23 shows an example “Work Areas” tool provided by user interface dashboard configured to facilitate review of workers 16 present in each work area in a specified period of time. In this example arrangement, the Work Areas tool provides collapsible lists of workers 16 determined to be located in each work area. In this example arrangement, the Work Areas tool lists workers 16 present in each work area along with the time at which the worker 16 was detected to be present in the work area. In this example arrangement, the Work Areas tool permits a user to select criteria to filter and/or sort worker entries and/or work areas displayed.

FIGS. 24-33 shown an example “Location Detail” tool provided by user interface dashboard configured to facilitate review of data gathered by monitoring system 14 in various different locations. As shown in FIGS. 24-31, in this example arrangement, the Location Detail tool includes a number of Tabs for display of data recorded by various sensors in a location and time period selected by a user. In this example arrangement, Tabs are available for display of temperature, humidity, heat index, CO2, TVOC, pressure, sound levels, and light levels. Such data may be useful to facilitate identification and evaluation of environmental risks presented in a location of interest.

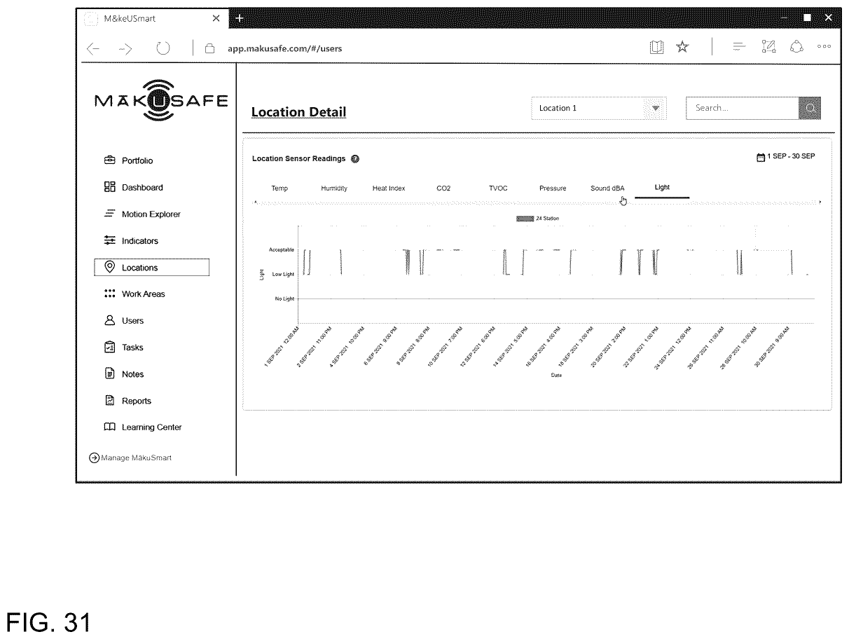

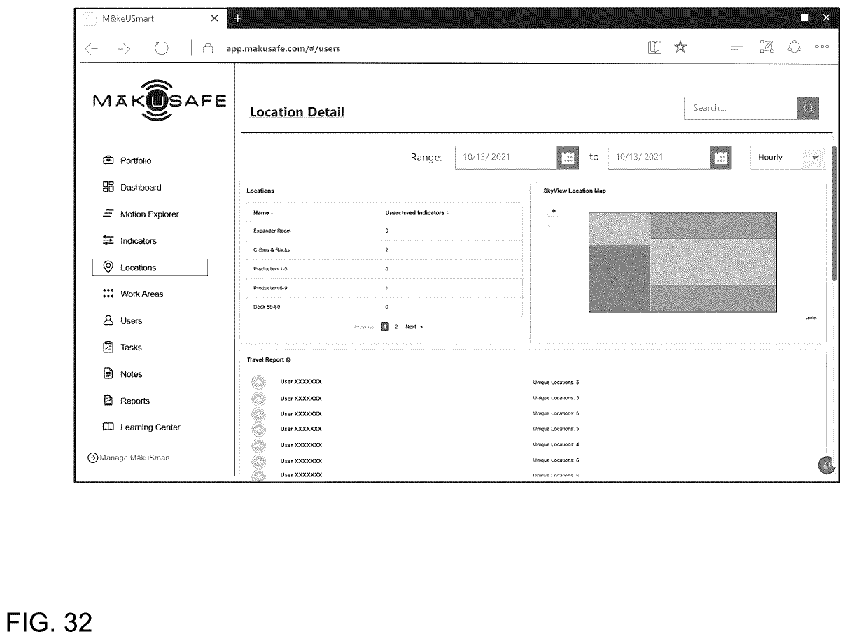

In one or more arrangements, the Location Detail tool is configured to facilitate review history of worker 16 travel in different areas of a location various locations for a selected period of time. FIG. 31 shows a summary risk indicators and travel of workers in different locations in a selected period of time. In this example arrangement, the Location Detail tool indicates risk indicators that were identified in the different locations within the selected time period. In this example arrangement, the Location Detail tool also displays a map of the locations to facilitate easy selection and review of data for specified locations (e.g., as shown in FIGS. 24-31). In this example arrangement, the Location Detail tool also displays a travel report for workers 16. In this example arrangement, the travel report indicates the number of unique locations visited by each worker 16 within the selected time period. In this example arrangement, the travel report ranks the users by the number of locations visited. Such ranking may be useful, for example to facilitate identification of workers 16 that visit many locations and thus are more likely to have overall risk that differs from a general risk for the workers 16 primary occupation or primary workstation. In this example arrangement, a user may select a specific user in the travel report to show a map summarizing travel of the worker, for example, as shown in FIG. 32. In the example map shown in FIG. 32, areas are color coded to indicate percentage of time the selected worker spent in each location in the selected time period.

However, the embodiments are not limited to the example user interface dashboard and tools shown in FIGS. 18-33. Rather, it is contemplated that system 10 may utilize any type of user interfaces, which may present data in any format or form, to facilitate review and evaluation of data gathered by monitoring system 14.

### Predictive Fatigue:

In addition to or in lieu of other analytics processes 70 discussed herein, in one or more arrangements, data processing system 62 is configured to utilize collected information to assess physicality exhibited by workers during a work shift and/or worker fatigue. In one or more arrangements, analytics processes 70 are configured to identify and/or predict fatigue in workers 16 based on one or more data metric indicative of physicality of workers 16 during a work shift (e.g., power exerted in movements).

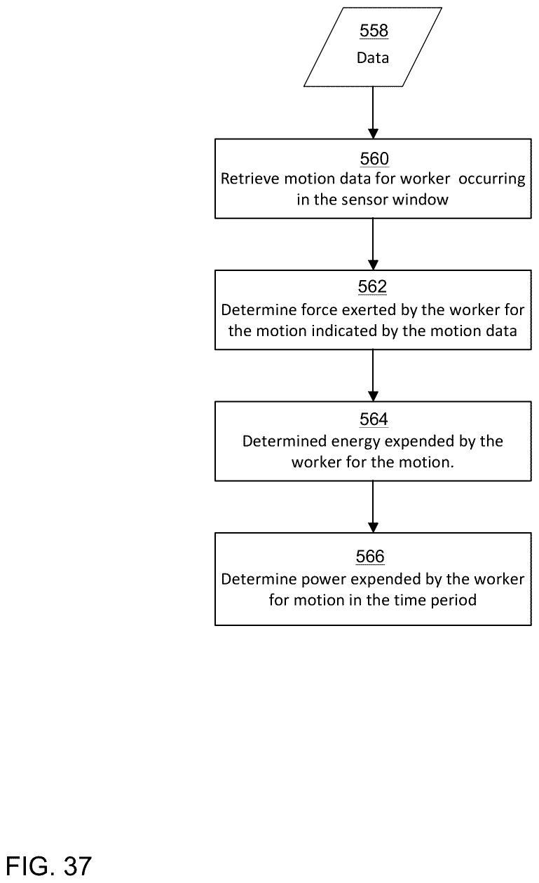

FIG. 37 shows an example dataflow arrangement for determining power exerted by a worker 16 over time, in accordance with one or more arrangements. At block 560, motion data 558 for the worker occurring in the sensor window is retrieved.

In this example, at processing block 562 force exerted by the worker in the motion is determined based on the magnitude of the acceleration vector as:

$$Force = mass * \vert \vec{a} \vert$$

In one or more arrangements, wearable devices 12 are configured to be worn on the upper arm (between the shoulder and elbow). In such arrangement, force would be calculated using the mass of the arm of the worker 16. In one or more arrangements, an estimated mass of an average arm (e.g., 4.5 kg) is used for force calculation. However, the embodiments are not so limited. Rather, it is contemplated that in some arrangements, analytics processes 70 may calculate force using a more accurate measurement of mass. For example, analytics processes 70 may calculate force using an individual mass measurement specific to each worker that is stored in database 60.

In this example, after calculating force energy is calculated at process block 564 as:

$$Energy ( J ) = Force * Distance ( meters )$$

In some arrangements, energy may be calculated using the actual distance moved in the window of sensor data (e.g. as indicated by a position sensor 22). In some arrangements, energy may be calculated using an estimated distance moved (e.g., 0.5 meters). After calculating energy, power is then calculated at process block 566 as:

$$Power = \frac{Energy}{time}$$

### Power Curves:

In one or more arrangements, analytics processes 70 are configured to identify and/or predict fatigue in workers 16 by constructing a curve of power exerted by a worker 16 during a work shift (referred to herein as a “power curve” 570). The power curve 570 indicates the determined power exerted for each window of sensor data (or calculation period).

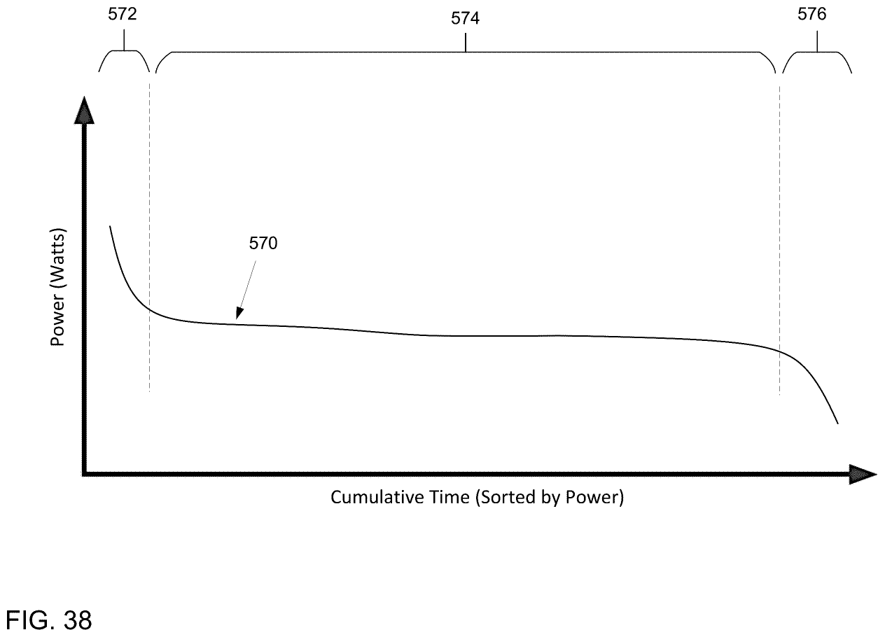

FIG. 38 shows an example power curve 570, in accordance with one or more arrangements. In this example, data values in the power curve 570 are sorted according to the level of power exerted, from highest to lowest. In this example, the left portion 572 of the power curve 570 with the highest values correlate to periods of time at which a worker 16 first begins physical exertion after resting and exhibits peak power. In such periods, the worker 16 exhibits an initial burst of strength and a high level of power which quickly fades (typically within seconds). The center plateau portion 574 of the power curve 570 represents the normal non-fatigued state of a worker, which is generally sustained for the majority of the work shift. While there may be variation in this center portion 574, the values are typically fairly consistent until workers 16 become fatigued. When workers 16 become fatigued, the power exerted rapidly dips as shown in the right portion 576 of the power curve 570. This dip represents when a worker's power output falls below the flatline and potentially suggests that they have entered a fatigued state.

### Baseline Power Curve:

In one or more arrangements, power and/or power curve 570 data of a worker 16 over a number of days is combined to generate a baseline power curve 578 (not shown). Various different arrangements nay utilize various means and/or methods to produce a baseline power curve 578. As one example, in some arrangements, a baseline power curve 578 may formed by averaging power curves 570 of the worker 16 for a set of previous work shifts (e.g., 30 or more days). Generally, the more days of power and/or power curve 570 data are included, the more accurate the baseline power curve 578 will be.

In one or more arrangements, analytics processes 70 use the baseline power curve 578 to assist in determining when a power curve 570 for a current work shift indicates when a worker 16 has and/or will become fatigued. For example, in one or more arrangements, analytics processes 70 are configured to dynamically create and update a power curve 570 for a worker 16 as motion data and/or data metrics are received from wearable device 12 of the worker 16 during the work shift. In one or more arrangements, analytics processes 70 are configured to evaluate the power curve 570 as it is created/updated to identify and/or predict when worker 16 is fatigued.

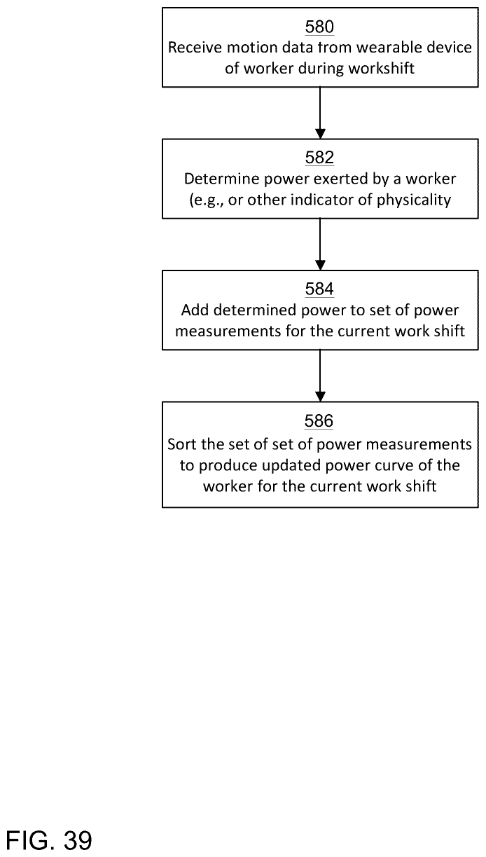

FIG. 39 shows an example process for dynamic creation and/or update of a power curve 570 during a work shift, in accordance with one or more arrangements. At block 580, motion data (and/or other data) received from wearable device 12 a time period of interest is retrieved (e.g., from database 60). At block 582, power exerted by the worker 16 (and/or other data metric(s) indicative of physicality) is derived from the retrieved data. At block 584, the process adds the determined power to a set of power measurements for the current work shift of the worker 16. At block 586, the set of power measurements for the work shift of the worker 16 is sorted to produce an updated power curve 570 for the work shift.

### Identification of Fatigue:

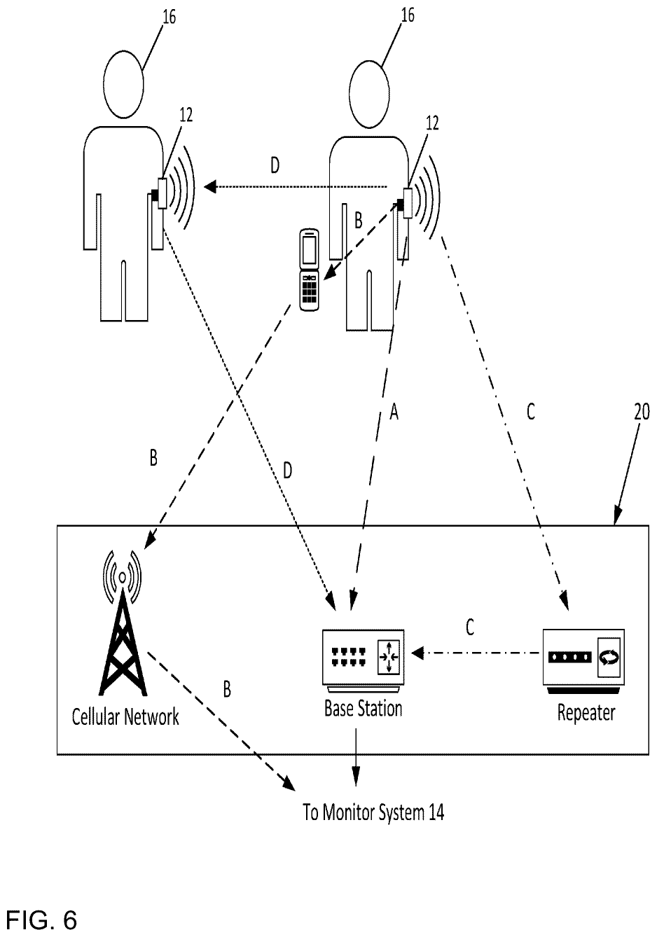

In one or more arrangements, after each time a power curve 570 of a worker 16 is updated, analytics processes 70 evaluate the power curve 570 to determine if the worker 16 is becoming fatigued. In some various arrangements, analytics processes 70 may utilize various methods and/or means to evaluate fatigue from the current power curve 570. In one or more arrangements, a baseline power curve 578 is evaluated to identify a lower threshold power level (e.g., threshold 590), below which a power curve 570 for the worker 16 is considered to be indicative of fatigue. The threshold level may be set, for example, based on the range of the baseline power curve 578 in the center plateau portion (e.g. portion 574 in power curve 570 of FIG. 6). For instance, in one or more arrangements, the threshold level may be set to a certain buffer amount below the minimum power level in the center portion of the baseline power curve 578. The buffer amount may help to ensure that fatigue is not prematurely detected by typical variation of power exhibited by a worker 16.

Additionally or alternatively, in one or more arrangements, analytics processes 70 may be configured to evaluate the baseline power curve 578 to identify certain trends that indicate that a worker is becoming fatigued. For instance, in some arrangement, such a trend may include, for example, the tail end of a power curve 570 having a certain downward slope (e.g., >−0.5×).

Additionally or alternatively, in one or more arrangements, analytics processes 70 may utilize artificial intelligence and/or machine learning algorithms trained, from a baseline power curve 578 and/or historical movement data, power, and/or other data metrics, to identify when a power curve 570 indicates a worker 16 is or will be fatigued. Such training may include, for example, generation and refinement of classifiers and/or state machines configured to map input data values (e.g. baseline power curves 578, motion data, and/or data metrics) fatigue levels. In various embodiments, analysis by the analytics processes 70 may include various guided and/or unguided artificial intelligence and/or machine learning techniques including, but not limited to: artificial neural networks, genetic algorithms, support vector machines, k-means, kernel regression, discriminant analysis and/or various combinations thereof. In different implementations, analysis may be performed locally, remotely, or a combination thereof.

### Prediction of Fatigue:

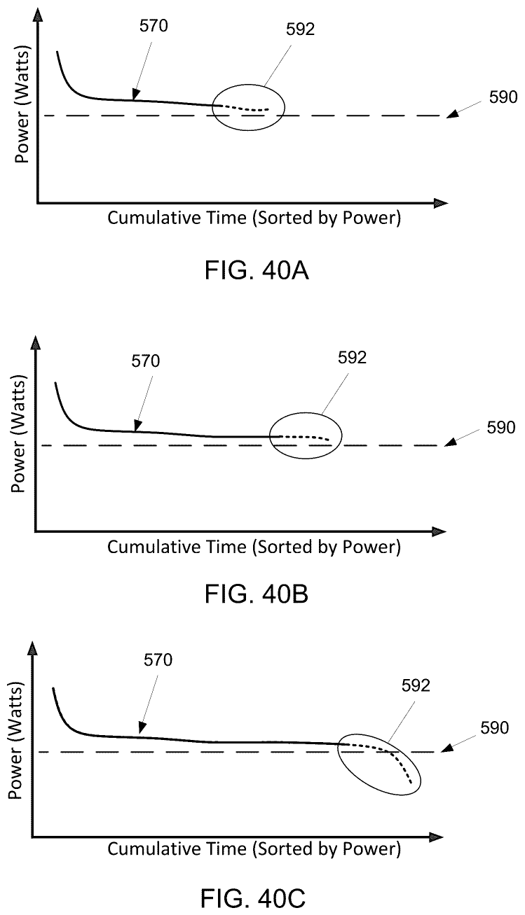

In one or more arrangements, analytics processes 70 are configured to evaluate a power curve 570 for a current work shift as it is updated to predict future values. FIGS. 40A, 40B, and 40C illustrate creation and assessment of an example power curve 570 at several points in time during a work shift for prediction of worker fatigue.

In this example, FIG. 40A shows an example power curve 570 updated at approximately 50% of the length of a work shift. In this example, a tail end of the power curve 570 is higher than the threshold 590, indicating that the power curve 570 is within the central plateau portion 574 and the worker has not yet become fatigued. Data points 592 are predicted future values generated by analytics processes 70 (e.g., based on the current power curve 570 and a baseline power curve 578). In this example, the predicted data points 592 are also above the threshold 590, indicating that the worker 16 is not predicted to become fatigued in the near future.

In this example, FIG. 40B shows power curve 570 updated at approximately 66% of the length of the work shift. In this example, a tail end of the power curve 570 remains higher than the threshold 590, indicating that the power curve 570 is within the central plateau portion 574 and the worker 16 has not yet become fatigued. In this example, the predicted data points 592 are also above the threshold 590, indicating that the worker 16 is not predicted to become fatigued in the near future.

In this example, FIG. 40C shows power curve 570 updated at approximately 80% of the length of the work shift. In this example, a tail end of the power curve 570 remains higher than the threshold 590, indicating that the power curve 570 is within the central plateau portion 574 and the worker 16 has not yet become fatigued. In this example, the predicted data points 592 dip below the threshold 590, indicating that the worker 16 is likely to become fatigued in the near future. In this manner, analytics processes 70 are able to take advanced action to mitigate risks presented by worker fatigue.

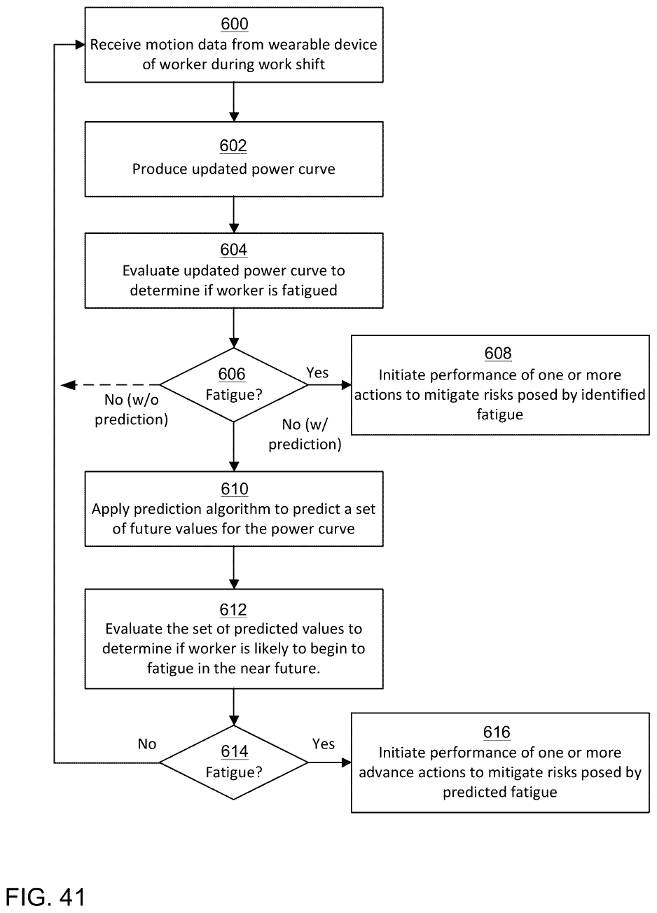

FIG. 41 shows an example process for dynamic creation and/or update of a power curve 570 and prediction of worker fatigue during a work shift, in accordance with one or more arrangements. At process block 600, motion data (and/or other data) received from wearable device 12 a time period of interest is retrieved (e.g., from database 60). At process block 602, a power curve 570 for the work shift is updated based on the received motion data (e.g., as described with reference to FIG. 7). At process block 604, the updated power curve 570 is evaluated to determine if the worker 16 has become fatigued. If the worker 16 is fatigued, the process proceeds from decision block 606 to process block 608, where monitoring system 14 initiates one or more actions are taken to mitigate risks presented by the identified fatigue. Otherwise, if the analytics processes 70 are not configured to predict fatigue, the process proceeds from decision block 606 back to process block 600 and the process is repeated.

If the analytics processes 70 are not configured to predict fatigue and fatigue is not identified in the updated power curve 570, the process proceeds from decision block 606 to process block 610. At process block 610, a prediction algorithm is applied to predict a set of future values for the power curve 570. In some various arrangements, analytics processes 70 may utilize various methods and/or means to predict future values from the current power curve 570.

For example, in some arrangements, analytics processes 70 may utilize artificial intelligence and/or machine learning algorithms trained, from a baseline power curve 578 and/or historical movement data, power, and/or other data metrics, to predict future values for the power curve 570. Such training may include, for example, generation and refinement of an artificial neural network or other machine learning algorithm to map input data values (e.g. baseline power curves 578, motion data, and/or data metrics) to fatigue levels, for example, using a gradient descent calculation to adjust the values of the artificial neural network/algorithm to minimize differences between predicted baseline power curve values and actual baseline power curve values. However, the arrangements are not so limited. Rather, it is envisioned that the analytics processes 70 may include various guided and/or unguided artificial intelligence and/or machine learning techniques including, but not limited to: artificial neural networks, genetic algorithms, support vector machines, k-means, kernel regression, discriminant analysis and/or various combinations thereof. In different implementations, analysis may be performed locally, remotely, or a combination thereof. At process block 612, the predicted values are evaluated to determine if the worker 16 is likely to begin to fatigue in the near future. If the worker 16 is likely to become fatigued in the near future, the process proceeds from decision block 614 to process block 616, where monitoring system 14 initiates one or more actions mitigate risks presented by the predicted fatigue.

### Not Limited to Power Based Assessment:

While the arrangements may be primarily described with reference to identifying/predicting fatigue from evaluation of power exhibited by workers 16, the embodiments are not so limited. Rather, it is contemplated that in one or more arrangements, fatigue assessment may additionally or alternatively be determined based on a variety of data including but not limited to, for example, motion data, work, power, heart rate, temperature, perspiration level, number of steps, distance traveled, and/or other data acquired by sensors 22 and/or derived by analytics processes 70 using data analytics (e.g., identification of repetitive motions).

Not Limited to Worker Specific Baseline Power Curves and/or Algorithms:

While some arrangements may be primarily described with reference to baseline power curves 578 that are created specific to individual workers 16, the arrangements are not so limited. Rather, it is contemplated that baseline power curves 578 may additionally or alternatively be more generically created for groups of workers (e.g., of the same job type), for specific work assignments or types of work, or any other classification of workers 16 or work assignments.

Similarly, it is contemplated that utilize artificial intelligence and/or machine learning algorithms (e.g., used for evaluation of fatigue and/or power curve prediction) may be trained for individual workers, for groups of workers, or for specific work assignments or types of work, or any other classification of workers 16 or work assignments.

In some arrangements, analytics processes 70 may be configured to utilize multiple different baseline power curves and/or multiple artificial intelligence and/or machine learning algorithms when evaluation of fatigue and/or predicting power curve data for a particular worker. For example, in some arrangements, fatigue evaluation and/or power curve data prediction may include using a combination of worker specific, group specific and/or work specific baseline power curves 578 and/or artificial intelligence and/or machine learning algorithms. For instance, in one or more arrangements, analytics processes 70 may be configured to perform respective power curve prediction assessments of a worker 16 using worker specific, group specific and/or work specific baseline power curve 578 and/or algorithms and combine the results (e.g., by averaging).

### Machine Learning/Artificial Intelligence (AI)

In some arrangements, data processing system 62 or other component of system 10 may be configured to perform one or more processes or tasks described herein using an LLM or other AI algorithm, which may include various guided and/or unguided artificial intelligence and/or machine learning techniques including, but not limited to, for example, neural networks, genetic algorithms, support vector machines, k-means, kernel regression, discriminant analysis and/or various combinations thereof. In different implementations, analysis may be performed locally, remotely, or a combination thereof.

In one or more embodiments, data processing system 62 and/or other components of system 10 may be configured to monitor, learn, and modify one or more features, functions, and/or operations of the system 10. For instance, analytics processes 70 of data processing system 62 may be configured to monitor and/or analyze data stored in database 60 and/or operation of system 10. As one example, in one or more arrangements, data processing system 62 may be configured to analyze the data and learn, over time, data metrics indicative of safety risks and/or algorithms for identification of safety risks. Such learning may include, for example, training and refinement of one or more AI algorithms configured to map data collected by wearable devices 12 values to outcomes and/or data metrics of interest (e.g., a set of identifiable safety risks) or to operations to be performed by the system 10. For example, with reference to the process shown in FIG. 15, in one or more arrangements one or more AI algorithms may be trained to perform the different physicality quantifications (e.g., based on power exerted, events of interest detected, and/or hours worked) and/or identify occurrence of various different safety hazards (e.g., trips/falls, near misses, repetitive motions that may lead to injury, etc.).

In one or more arrangements, various processes/tasks/evaluations may be performed using a commercial or pretrained LLM or other AI algorithm. In one or more arrangements, such processes/tasks may be performed using a custom LLM or other AI algorithm that is specifically trained to perform the particular processes/tasks.

In some arrangements, the same instance of the LLM or other AI algorithm may be trained for use with multiple different processes/tasks/evaluations. For instance, a single AI algorithm may be trained to identify from motion data of wearable device 12 when trip/fall incidents occur and also identify when a worker is performing repetitive or other dangerous motions that may lead to injury.

However, training AI to assist with multiple different processes/tasks/evaluations can be difficult due to “catastrophic forgetting”, where improvements achieved from training for a first task are diminished or lost when the AI is trained for a second process or task.

In one or more arrangements, system 10 is configured to train the LLM or other AI algorithm for performance of multiple different processes/tasks in a manner that avoids such catastrophic forgetting. As an example process, training may include the steps of:
1) Inputting a first set of data;
2) Training parameters of the LLM/AI algorithm using the first set of data for performance of a first process/task;
3) Inputting a 2^{nd} set of data;
4) Further training the AI algorithm for the LLM/AI algorithm on the 2^{nd} set of data for performance of a 2^{nd} process/task while preserving performance by the AI algorithm of the 1^{st} process/task; and
******
5) Repeat steps 3 and 4 as needed for additional sets of data for training AI algorithm for the LLM Service for performance of additional processes/tasks.

For additional information on training of LLMs and/or other AI algorithms reference may be made to U.S. Patent Publication No. 2019/0236482 published Aug. 1, 2019 and titled “TRAINING MACHINE LEARNING MODELS ON MULTIPLE MACHINE LEARNING TASKS”, which is hereby incorporated by reference herein.

In one or more arrangements, data processing system 1000 may additionally include one or more application specific integrated circuits (ASICs) (not shown) to facilitate local implementation of an LLM or other AI algorithm. For example, in one or more arrangements, data processing system 1000 may include an ASIC configured to implement an artificial neural network (ANN) that is trained to provide an LLM or other artificial intelligence process. As an illustrative example, in some arrangements the ACIS includes a plurality of neurons organized in an array, wherein each neuron comprises a register, a microprocessor, and at least one input; and a plurality of synaptic circuits, each synaptic circuit including a memory for storing a synaptic weight, wherein each neuron is connected to at least one other neuron via one of the plurality of synaptic circuits. In one or more arrangements, the synaptic circuits are trained to implement an LLM or other AI algorithm configured to perform one or more processes/tasks/evaluations described herein and/or shown in the figures. In one or more arrangements, analytics processes 70 are configured to utilize physicality ratings data of workers 16 to select data for training of classifiers (or other machine learning algorithms). Such selection of data may be used, for example, to facilitate supervised training of machine learning algorithms. For example, data of workers 16 having high physicality ratings may be used to train machine learning algorithms to identify high physicality, safety risks from other data metrics, sensor data, and/or evaluation criteria.

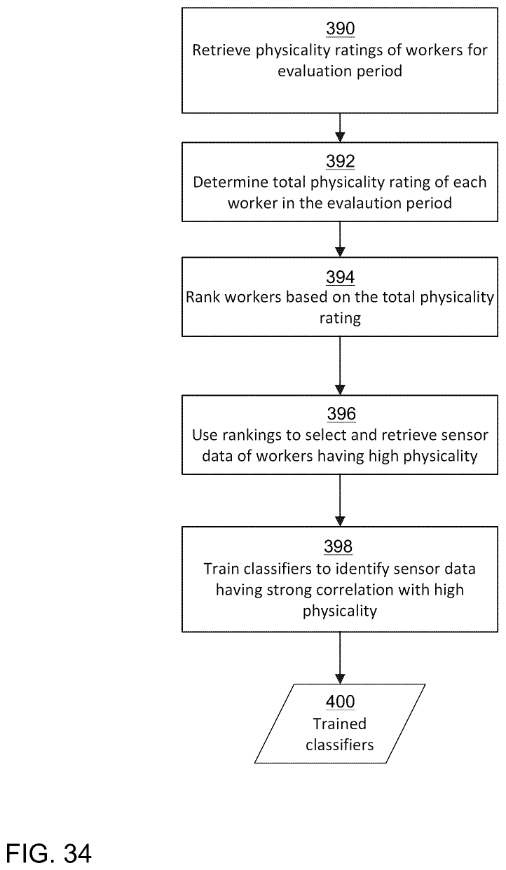

FIG. 34 shows an example analytics process for performing analytics of data received by monitoring system 14 and training of an AI algorithm, in accordance with one or more arrangements. At process block 390, the physicality ratings of workers 16 are retrieved (e.g., from database 60) for each work shift within a specified evaluation period. At process block 392, a total physicality rating is determined for each worker 16 for the evaluation period. In one or more arrangements, total physicality rating for a worker 16 may be determined by calculating an average of the retrieved physicality ratings of the worker 16 for the evaluation period. In this example, workers 16 are ranked based on the determined total physicality rating at process block 394. At block 396, physicality rankings are used to select and retrieve data of workers having high physicality ratings (and/or having low physicality ratings). At block 398, classifiers (or other machine learning algorithms) are trained using the retrieved data to produce trained classifiers 400.

In one or more arrangements, trained classifiers or other AI algorithms may be utilized to identify additional events of interest. For example, in some arrangements, new and/or improved trained classifiers 400 or other AI algorithms may be communicated to wearable devices 12 when connected to charging base 18. Wearable devices 12 may be configured to use the trained classifiers 400 or other AI algorithms to identify events of interest. Depending on how the data utilized as inputs by classifiers (or other AI algorithms), such events of interest may be identified using new additional sensor data and/or criteria. In this manner, detection of events of interest may be automatically improved over time to better identify events corresponding to high physicality and/or high safety risk.

### Management Software 74:

In one or more arrangements, information provided by wearable devices 12 is processed by management software 74. In one or more arrangements, in response to receiving data for an event of interest (e.g., an accident or near-miss), management software 74 converts the information into an incident report and a signal, such as a text message, email, or the like is transmitted to an electronic device (such as a cell phone, a handheld device, their own wearable device 12, an email account, or any other electronic device capable of receiving an electronic message or information) of one or more safety managers or other managers or other persons in charge of managing safety in the manufacturing facility. This signal includes the position/location of the event, time of the event, name of the worker 16 involved and type of potential accident or near miss along with any other pertinent information. In one or more arrangements, the audible recording of the worker's 16 description of the accident or near miss is also transmitted, or this audible recitation is automatically converted to text which is transmitted in text form as part of this signal. With this timely information, the safety manager can quickly and effectively respond to the potential accident or near miss. This information is also stored as an incident report in database 60 for risk assessment, data mining, data retrieval, data analytics, and/or machine learning and artificial intelligence purposes.

As this event is a safety event, transmission is expedited through the system 10 so that the safety manager, a response team or others can quickly respond in an attempt to mitigate the injury or damage. In one or more arrangements, when this signal indicating a safety event occurred is received, the location of the event is transmitted to a building control or safety system that then implements alarms, flashing lights or other safety precautions in the affected portion of the manufacturing facility to alert others as to the event and in an attempt to prevent further injury or damage. Once the safety manager arrives at the scene of the accident or near miss they may see that a pallet was placed in a high traffic area, as one example. In response, the safety manager can move the pallet or cordon off the area to prevent future accidents and/or take further corrective actions.

### Trigger Actions Based Data Gathered by Wearable Devices 12:

In one or more arrangements, management software 74 (and/or analytic processes 70) may be configured to perform various actions in response to data provided by wearable devices satisfying certain criteria. For example, in one or more arrangements, monitoring system 14 may be configured to generate control signals and/or control various equipment or switching of one or more relay switches (not shown) in response to data received from a wearable device 12 satisfying a particular set of criteria. For example, in one or more arrangements, management software 74 may be configured to control operation of various devices (e.g., lights, alarms, locks, doors, and/or any other devices) based on location of wearable devices 12.

As another example, in some arrangements, management software 74 may be configured to perform various actions based on fatigue status of workers 16. For example, in one or more arrangements, management software 74 may be configured to generate reports, send alerts to workers 16 and/or managers (e.g., text message, IM. email, automated call, and/or other means for communication), and/or initiate one or more mitigative actions in response to analytics processes 70 determining or predicting that a worker 16 is fatigued or will become fatigued in the near future.

### Example Mitigative Actions:

In some various arrangements, management software 74 is configured to automatically initiate various different actions to mitigate risks presented by the identified and/or predicted fatigue of workers 16. In some various arrangements, management software 74 realizes an improvement in operations and safety by avoiding the delay involved in waiting for an administrator to react to detected/predicted fatigue by automatically performing such actions.

### Status Boards and Alerts:

As an illustrative example, some worksites have status boards (not shown) located nearby production lines and/or workstations identifying workers 16 currently working on the production line and/or workstation. The status board may also show additional information for each worker 16 such as time started, length of time at the production line and/or workstation, time scheduled for shift rotation, and/or any other relevant information.

As a mitigative measure, in one or more arrangements, monitoring system 14 may be configured to cause the status board to provide one or more visual indicators (e.g., color, warning icon, flashing, etc.) to indicate when workers 16 are identified as being fatigued or predicted to become fatigued in the near future. In some arrangement, monitoring system 14 may be configured to dynamically quantify a fatigue level for each worker during the work shift and cause status board to display a visual indicator of the fatigue level for each worker (e.g., text, percentage, gauge, life meter, etc.). Additionally or alternatively, in one or more arrangements, monitoring system 14 may be configured to initiate audible, haptic, electronic messaging alerts (e.g., email, SMS, IM, and/or any other electronic messaging) in response to identifying that a worker 16 is or will likely become fatigued in the near future.

In this manner workers and/or managers can quickly assess status of workers 16 and rotate workers off of dangerous work assignment when identified as fatigued or predicted to become fatigued in the near future.

Restricting Permitted Access and/or Operation for Fatigued Workers:

As an example mitigative measure, in one or more arrangements, monitoring system 14 may be configured to automatically control operation of various other production equipment and/or devices based on the fatigue status of workers 16 to mitigate risk of accident and/or injury. For example, in one or more arrangements, monitoring system 14 may be configured to disable dangerous machinery and/or adjust permissions of a workers, for example, to prevent a worker 16 that has been identified as or predicted to soon be fatigued from access/using dangerous machinery and/or locations.

For instance, in one or more arrangements, monitoring system 14 may be configured to generate control signals and/or control switching of one or more relay switches (not shown) in response to determined worker statuses (fatigue, locations, etc.) and/or based on other sensor data gathered by wearable devices 12. Such control signals and/or relay switches may be configured to control operation of various devices (e.g., lights, alarms, locks, doors, equipment, and/or any other devices) to mitigate risks posed by fatigued workers 16.

As an illustrative example, in one or more arrangements, monitoring system 14 is configured to control a relay switch connected to a door lock to control access to an area that is restricted due to high risk of injury. To enable access, a worker 16 may hold their wearable device 12 near a nearby sensor to identify the worker 16 to the system 10. Once identified, monitoring system 14 may check permissions of the worker 16 to verify that the worker is permitted access. If access is permitted, the monitoring system 14 may then cause relay switch to unlock the door lock. However, in one or more arrangements, the monitoring system 14 may be configured to deny access to a worker 16 normally permitted access to the restricted area if the worker 16 is determined to be or predicted to soon be fatigued. In this manner, fatigued worker can be kept away from potentially dangerous areas while fatigued.

As another illustrative example, in one or more arrangements, monitoring system 14 is configured to enable/disable operation of certain dangerous equipment (e.g., forklift, saw, lathe, etc.) so as to only permit authorized workers 16 to operate such equipment.

To enable operation, a worker 16 may hold their wearable device 12 near a nearby sensor to identify the worker 16 to the system 10. Once identified, monitoring system 14 may check permissions of the worker 16 to verify that the worker is authorized to operate the equipment. If operation is permitted, the monitoring system 14 may then prompt a cause relay switch (or other control circuit) to enable operation of the equipment. However, in one or more arrangements, the monitoring system 14 may be configured to keep the equipment disabled for the worker 16 normally authorized to operate if the worker 16 is determined to be or predicted to soon be fatigued. In this manner, fatigued worker can be prevented from operating potentially dangerous equipment while fatigued.

### Automated Scheduling of Breaks for Workers:

As yet another example mitigative measure, in one or more arrangements, monitoring system 14 may be configured to automatically prompt a worker 16 to take breaks, switch to a less demanding work assignment, and/or move to a more comfortable area in response to determining the worker 16 is fatigued or will become fatigued in the near future. In some arrangements, monitoring system 14 may prompt the worker 16 directly, for example by sending a message or alert (e.g., via visual alert, audible alert, email, SMS, IM, or other electronic messaging) to the worker 16, or prompt the worker 16 indirectly, for example, by sending a message or alert to a manager. However, the arrangements are not so limited. Rather, it is contemplated that in various arrangements, monitoring system 14 may be configured to automatically prompt a worker 16 to take breaks, switch to a less demanding work assignment, and/or move to a more comfortable area using any known method and/or means.

### Not Limited to the Example Mitigating Actions:

It should be recognized that the arrangements are limited to these example actions to mitigate risk. Rather, it is contemplated that in some various arrangements, monitoring system 14 may be configured to (or customized by an authorized user for the work site to) automatically perform any action in response to identifying a worker as being fatigued and/or predicting a worker 16 will become fatigued in the near future.

From the above discussion, it will be appreciated that one or more arrangements provide a wearable device, system, and/or method of use that improve upon the state of the art. Specifically, one or more arrangements provide a wearable device, system, and/or method: for collecting, reporting and analyzing information indicative of work performed by workers and/or conditions that workers are exposed to in a workplace to better assess physicality of workers and safety risk posed to workers 16 during a work shift: that improves upon the state of the art; that collects information about the work performed by workers and workplace conditions; that utilizes an adaptive method of communication to communicate data from wearable devices to a monitoring system; that ensures that all data is communicated to the monitoring system when communication is intermittent; that utilizes an adaptive method of communication that utilizes multiple different networks; that utilizes an adaptive method of communication that utilizes infrastructure and ad hoc networks; that utilizes an adaptive method of communication that adjusts the method of communication to fit the needs of each worker; that utilizes an adaptive method of communication that adjusts the method of communication based on the work schedule of each worker; that utilizes an adaptive method of communication that is energy efficient; that utilizes an adaptive method of communication that facilitates communication from nearly any location; that aggregates a great amount of information about the work performed by workers and workplace conditions; that eliminates bias in the collection of information about the work performed by workers and workplace conditions; that eliminates the inconsistency in reporting information about the work performed by workers 16 and workplace conditions; that utilizes collected information to assess physicality exhibited by workers during a work shift; that utilizes collected information to assess safety risks faced during a work shift; that aggregates a great amount of information indicative of work performed by workers and workplace conditions to facilitate data analytics; that is cost effective; that is safe to use; that is easy to use; that is efficient to use; that is durable; that is robust; that can be used with a wide variety of manufacturing facilities; that is high quality; that has a long useful life; that can be used with a wide variety of occupations; that provides high quality data; and/or that provides data and information that can be relied upon.

These and countless other objects, features, or advantages of the present disclosure will become apparent from the specification, figures, and claims.

What is claimed:

1. A system for monitoring worker activity, comprising:
a wearable device;
the wearable device configured to be worn by a worker during a work shift;
the wearable device having a plurality of sensors;
a monitoring system;
wherein the wearable device communicates data collected from the plurality of sensors to the monitoring system using a first communication method when located on a premises;
wherein the wearable device communicates data collected from the plurality of sensors to the monitoring system using a second communication method when located off of the premises.

2. The system of claim 1, wherein in the first communication method, the wearable device communicates over a first communication network;
wherein in the second communication method, the wearable device communicates over a second communication network.

3. The system of claim 1, wherein in the first communication method, the wearable device communicates over a WiFi network;
wherein in the second communication method, the wearable device communicates over a mobile network via a mobile device.

4. The system of claim 1, wherein in the first communication method, the wearable device communicates over an infrastructure network;
wherein the wearable device is configured to communicate using in a third communication method when located on the premises and the infrastructure network is unavailable;
wherein in the third communication method, the wearable device communicates over an ad hoc wireless network formed by the wearable device and one or more additional wearable devices.

5. The system of claim 1, wherein the monitoring system is configured to perform analytics on the data received from the wearable device.

6. The system of claim 1, wherein the monitoring system is configured to perform analytics on the data received from the wearable device to quantify physicality exhibited by the worker during the work shift.

7. The system of claim 1, wherein the monitoring system is configured to perform analytics on the data received from the wearable device to identify potentially dangerous events.

8. The system of claim 1, wherein the monitoring system is configured to perform analytics on the data received from the wearable device to identify repetitive motions of the worker.

9. A system for evaluating worker safety, comprising;
a plurality of wearable devices;
a monitoring system communicatively connected to the plurality of wearable devices;
wherein each of the plurality of wearable devices is configured to be worn by a worker during a work shift;
wherein each of the plurality of wearable devices includes one or more sensors;
wherein each of the plurality of wearable devices is configured to:
derive a set of data from the one or more sensors; and
communicate the set of data from the one or more sensors to the monitoring system using an ad hoc wireless network including the plurality of wearable devices;
wherein the plurality of wearable devices are each configured to indicate a weight corresponding to the number of hops in the ad hoc wireless network to a base station;
wherein the plurality of wearable devices are each configured to detect a set of the plurality of wireless devices within range and select the wireless device of the set having the lowest weight for the device to communicate data to the monitoring system.

10. The system of claim 9 wherein each of the plurality of wireless devices are configured to indicate a weight equal to a weight of the selected one of the plurality of wireless devices plus one.

11. The system of claim 9, wherein the plurality of wireless devices are configured to communicate data to the monitoring system over an infrastructure network when available;
wherein the plurality of wireless devices are configured to communicate data to the monitoring system over the ad hoc wireless network when the infrastructure network is unavailable.

12. The system of claim 9, wherein the plurality of wireless devices are configured to communicate data to the monitoring system over an infrastructure network when available;
wherein the plurality of wireless devices are configured to communicate data to the monitoring system over the ad hoc wireless network when the infrastructure network is unavailable;
wherein the plurality of wireless devices are configured to communicate data to the monitoring system over a mobile network via one or more mobile devices.

13. The system of claim 9, the plurality of wearable devices are configured to communicate data to the monitoring system over an infrastructure network; when available
wherein the plurality of wearable devices are configured to communicate data to the monitoring system over the ad hoc wireless network when the infrastructure network is unavailable.

14. The system of claim 9, wherein the monitoring system is configured to perform analytics on the data received from the plurality of wearable devices.

15. The system of claim 9, wherein the monitoring system is configured to perform analytics on the data received from the plurality of wearable devices to quantify physicality exhibited by the worker during the work shift.

16. The system of claim 9, wherein the monitoring system is configured to perform analytics on the data received from the plurality of wearable devices to identify potentially dangerous events.

17. The system of claim 9, wherein the monitoring system is configured to perform analytics on the data received from the plurality of wearable devices to identify repetitive motions of the worker.

18. A system for evaluating worker safety, comprising;
a plurality of wearable devices;
a monitoring system communicatively connected to the plurality of wearable devices;
wherein each of the plurality of wearable devices is configured to be worn by a worker during a work shift;
wherein each of the plurality of wearable devices includes one or more sensors;
wherein each of the plurality of wearable devices is configured to:
derive a set of data from the one or more sensors; and
communicate the set of data from the one or more sensors to the monitoring system using an adaptive communication network;
wherein the adaptive communication network is configured to:
attempt to communicate the set of data to the monitoring system over a WiFi network;
in response to the attempt to communicate the set of data to the monitoring system over the WiFi network being unsuccessful, attempt to communicate the set of data to the monitoring system over an ad hoc wireless network of the plurality of wearable devices;
in response to the attempt to communicate the set of data to the monitoring system over the ad hoc wireless network being unsuccessful, establish a connection with a mobile device and attempt to communicate the set of data to the monitoring system over a cellular network via the mobile device;
in response to the attempt to communicate the set of data to the monitoring system over the cellular network via the mobile device being unsuccessful, storing the set of data in a non-volatile memory for later communication to the monitoring system.
